(19) United States
(12) Patent Application Publication
(10) Pub. No.: US 2011/0158426 A1
(43) Pub. Date: Jun. 30, 2011

(54) SIGNAL PROCESSING APPARATUS, MICROPHONE ARRAY DEVICE, AND STORAGE MEDIUM STORING SIGNAL PROCESSING PROGRAM

(75) Inventor: Naoshi MATSUO, Kawasaki (JP)

(73) Assignee: FUJITSU LIMITED, Kawasaki (JP)

(21) Appl. No.: 12/977,341

(22) Filed: Dec. 23, 2010

(30) Foreign Application Priority Data
Dec. 28, 2009 (JP) 2009-298951

(51) Int. Cl. H04R 3/00; H04B 15/00

(52) U.S. Cl. 381/92; 381/94.1

(57) ABSTRACT

A signal processing apparatus includes: two sound input units, an orthogonal transformer to transform two sound signals input from the two sound input units into respective spectral signals in a frequency domain, a phase difference calculator to calculate a phase difference between the spectral signals in the frequency domain, a range determiner to determine a coefficient responsive to a frequency in the phase difference as a function of frequency, and determine a suppression range related to a phase on a per frequency basis of the frequency responsive to the coefficient; and a filter to phase-shift a component of one of the spectral signals on a per frequency basis in order to generate a phase-shifted spectral signal when the phase difference at each frequency falls within the suppression range, synthesizing the phase-shifted spectral signal and the other of the spectral signals in order to generate a filtered spectral signal.

### CROSS-REFERENCE TO RELATED APPLICATIONS

This application is based upon and claims the benefit of priority of the prior Japanese Patent Application No. 2009-298951, filed on Dec. 28, 2009, the entire contents of which are incorporated herein by reference.

### FIELD

Various embodiments described herein relate to a noise suppressing process of a sound signal and an apparatus for implementing same.

### BACKGROUND

In a configuration with a microphone array that includes at least two microphones, the microphone array processes a sound signal that is received and converted, thereby setting a sound reception range in a sound source direction to a target sound or controlling a directivity thereof. The microphone array thus performs a noise suppression process or a target sound enhancement process.

In a typical microphone array device, the signal-to-noise ratio (S/N ratio) thereof is increased by controlling a directivity thereof in response to a time difference between received signals from a plurality of microphones, and a subtraction process or an addition process is performed. Unwanted noise in a sound coming in from a direction different from a sound reception direction of a target sound or coming in from a suppression direction is thus suppressed. The target sound in the sounds coming in from the same direction as the sound reception direction of the target sound or coming in from an enhancement direction is thus enhanced.

According to the technique discussed in Japanese Laid-Open Patent Publication No. 11-298988, a plurality of microphones receiving a plane sound wave are arranged at regular spacing in a line in a typical device. The typical device controls directivity characteristics of the microphones arranged in a voice recognition device used in a car navigation system mounted on a vehicle. When a voice of a talker reaches a location where the microphones are arranged, the voice in a spherical sound wave almost becomes a plane sound wave. It is thus assumed that the voice is a plane sound wave. A microphone circuit processes output signals from a plurality of microphones. The microphone circuit controls the directivity of the microphones in accordance with a difference in the phase of the plane sound wave input to the microphones such that a gain of the microphone circuits reaches a peak to the direction to the talker and that the gain is lowered in an incoming direction of noise.

According to the technique discussed in Japanese Laid-Open Patent Publication No. 2003-337164, a plurality of object position fixing apparatuses of related art include an acoustic measurement device that determines a phase difference spectrum of two-channel acoustic signals obtained from two microphones arranged with a specific spacing therebetween, and a pre-amplifier. The position fixing apparatus includes an arithmetic processing device. The arithmetic processing device calculates all sound source directions estimable from the phase difference spectrum determined by the acoustic measurement device. The arithmetic processing device determines frequency characteristics of the estimated sound source direction, and extracts a linear component parallel to a frequency axis from the frequency characteristics of the estimated sound source direction. A plurality of sound source directions may be reliably identified in a manner free from the distance between the sound source and the microphones in a real echoing environment without the need for measuring transfer characteristics of space in advance.

Japanese Laid-Open Patent Publication No. 2006-254226 discusses an acoustic signal processing apparatus of related art. In the acoustic signal processing apparatus, two units of amplitude data of microphone input by an acoustic signal input unit are analyzed by a frequency decomposer, and a two-dimensional data generator determines a phase difference between the two units of amplitude data on a per frequency basis. Two dimensional coordinate values are imparted to the phase difference on a per frequency basis in two-dimensional data generation. A drawing detector analyzes the generated two-dimensional data on an XY plane to detect a drawing. A sound source information generator processes the information of the detected drawing, and generates sound source information. The sound source information includes the number of sound sources as generators of acoustic signals, a space where each sound source is present, a time period throughout which the sound emitted by each sound source is present, a component structure of each sound source, separated sounds from each sound source, and symbolic content of each sound. According to this technique, restrictions on the sound source are relaxed, and the sound sources of the number larger than the number of microphones may be handled.

### SUMMARY

According to an aspect of the invention, a signal processing apparatus and method is provided. The signal processing apparatus includes: two sound input units, an orthogonal transformer to transform two sound signals input from the two sound input units into respective spectral signals in a frequency domain, a phase difference calculator to calculate a phase difference between the spectral signals in the frequency domain, a range determiner to determine a coefficient responsive to a frequency in the phase difference as a function of frequency, and determine a suppression range related to a phase on a per frequency basis of the frequency responsive to the coefficient, and a filter to phase-shift a component of one of the spectral signals on a per frequency basis in order to generate a phase-shifted spectral signal when the phase difference at each frequency falls within the suppression range, synthesizing the phase-shifted spectral signal and the other of the spectral signals in order to generate a filtered spectral signal. The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an arrangement of an array of at least two microphones as a sound input unit or a sound signal input unit according to one embodiment;

FIG. 2 illustrates a general structure of a microphone array device of an embodiment;

FIG. 3A illustrates a first portion of a general functional structure of a microphone array device;

FIG. 3B illustrates a second portion of a general functional structure of a microphone array device;

FIG. 3C illustrates a power spectrum in a sound signal segment of a target sound source and a power spectrum in a noise segment;

FIG. 4 illustrates a relationship of a phase difference of a phase spectral component calculated on a per frequency basis by a phase difference calculator, a sound reception range, a suppression range, and a shift range in an initial set state;

FIG. 5A illustrates a set state of a sound reception range, a shift range, and a suppression range responsive to a statistical mean value of gradient D(f) of phase differences in a limited sound reception range state;

FIG. 5B illustrates a set state of a limited sound reception range, a shift range, and a suppression range responsive to another gradient in the limited sound reception range state;

FIG. 5C illustrates a set state of a limited sound reception range, a shift range, and a suppression range responsive to another gradient in the limited sound reception range state;

FIG. 5D illustrates a set state of a limited sound reception range, a shift range, and a suppression range responsive to another gradient in the limited sound reception range state;

FIG. 5E illustrates a set state of a limited sound reception range, a shift range, and a suppression range responsive to another gradient in the limited sound reception range state;

FIG. 6A illustrates a relationship of a phase difference of a phase spectral component with respect to frequency including a relationship of a sound reception range, a suppression range, and a shift range at a specific gradient of a phase difference in a limited sound reception range state;

FIG. 6B illustrates a relationship of the phase difference of the phase spectral component with respect to frequency including a relationship of a sound reception range, a suppression range, and a shift range at another specific gradient of a phase difference in a limited sound reception range state;

FIG. 6C illustrates a relationship of a phase difference of a phase spectral component with respect to frequency, including a relationship of a sound reception range, a suppression range, and a shift range at another specific gradient of a phase difference in a limited sound reception range state;

FIG. 6D illustrates a relationship of a phase difference of a phase spectral component with respect to frequency including a relationship of a sound reception range, a suppression range, and a shift range at another specific gradient of a phase difference in a limited sound reception range state;

FIG. 6E illustrates a relationship of the phase difference of the phase spectral component with respect to frequency including a relationship of a sound reception range, a suppression range, and a shift range at another specific gradient of the phase difference in a limited sound reception range state;

FIG. 7 is a flowchart of a generation process of a complex vector executed by a digital signal processor (DSP) of FIGS. 3A and 3B;

FIG. 8A illustrates a first portion of a general functional structure of a microphone array device;

FIG. 8B illustrates a second portion of a general functional structure of a microphone array device;

FIG. 9 is a flowchart of a generation process of a complex vector executed by a digital signal processor of FIGS. 8A and 8B; and

FIGS. 10A and 10B illustrate a set state of a maximum sound reception range set in response to data of a sensor or key input data.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

In a sound signal processing process based on a plurality of sound input units, each sound signal is processed in a time domain. For example, a delay and subtraction process is performed on samples of each sound signal in order to form a suppression direction opposite a sound reception direction of a target sound. This method sufficiently suppresses noise coming in from the suppression direction. Background noise, such as a cruising noise in a car or noise in a crowded street, typically comes in from a plurality of directions. Such background noise comes in from a plurality of directions with respect to the suppression direction, and the incoming direction itself changes with time. A sound source direction may also change depending on a difference in characteristics between sound input units. The noise is difficult to suppress sufficiently in such a case.

The general discussion of signal processing heretofore and the detailed discussion of signal processing that follows are provided to explain typical examples, and are not intended to limit the scope of the invention.

The embodiments are described with reference to the drawings. In the drawings, like elements are designated with like reference numerals.

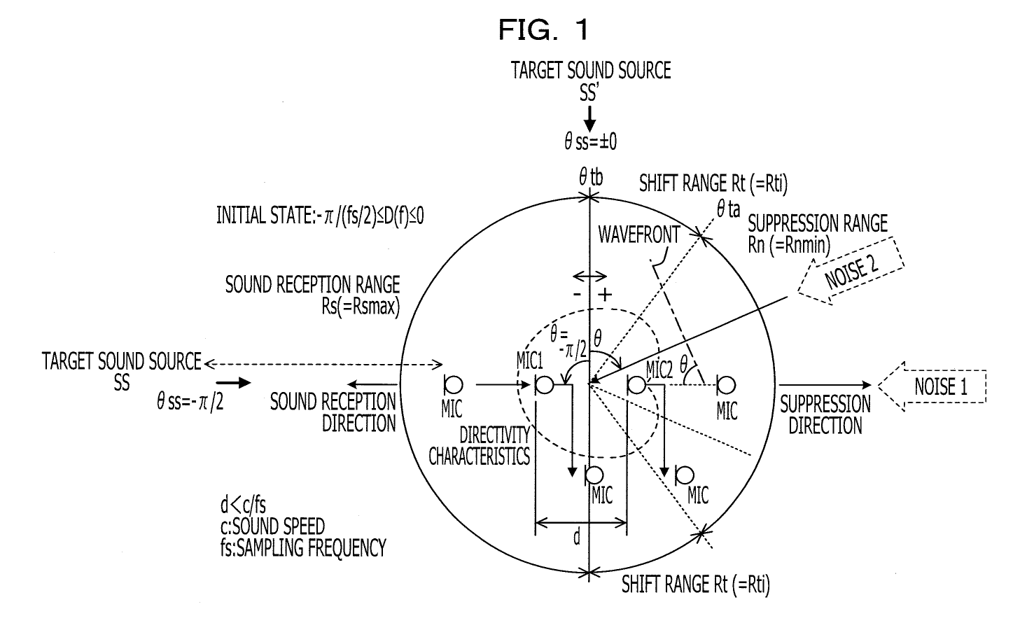

FIG. 1 illustrates an array of at least two microphones MIC1 and MIC2 as a sound input unit or a sound signal input unit in one embodiment.

A plurality of microphones, two microphones MIC1 and MIC2 here, are typically arranged to be spaced from each other with a known linear distance d therebetween. For example, the microphone MIC1 is spaced from the microphone MIC2 by a linear distance of d. The spacing between a plurality of microphones are not necessarily equal to each other. As long as the sampling theorem is satisfied, any known distance is acceptable.

According to one embodiment, the microphones MIC1 and MIC2 out of a plurality of microphones are used.

Referring to FIG. 1, an angle is referenced to the center of a line segment connecting the two microphones. As illustrated in FIG. 1, a main target sound source SS is placed in a line extending and connecting the microphones MIC1 and MIC2, and to the left of the microphone MIC1. The direction to the target sound source SS (−π/2) is a main sound reception direction or a target direction of the microphone array of microphones MIC1 and MIC2. For example, the sound source SS as a sound reception target is the mouth of a talker, and the sound reception direction is the direction to the mouth of the talker. An angular range of a sound reception angle may be a sound reception angular range Rs=Rsmax. Rsmax represents a maximum sound reception angular range Rs in an initial set state.

A direction opposite the sound reception direction (+π/2) is referred to as a main suppression direction of noise. An angular range of the main suppression angle at the main suppression direction may be a suppression angular range Rn=Rnmin of noise. Rnmin represents a minimum suppression angular range Rn in the initial set state.

A shift angular range Rt=Ri is defined on both sides of the sound reception angular range Rs=Rsmax in the initial set state to increase a noise suppression amount gradually as angular position becomes close to the suppression angular range Rn. Rti represents the shift angular range Rt in the initial set state. A minimum suppression angular range Rn=Rnmin, as the remaining angular range, is arranged next to the shift angular ranges Rti. An angular border between the shift angular range Rt and the suppression angular range Rn is represented by θta, and an angular border between the sound reception angular range Rs and the shift angular range Rt is represented by etb. The sound reception angular range (hereinafter simply referred to as reception range) Rs, the shift angular range (hereinafter referred to as a shift range) Rt, and the suppression angular range (hereinafter referred to as a suppression range) Rn may be determined on a per frequency f basis.

In one embodiment, the spacing d between the microphones MIC1 and MIC2 is set to satisfy a condition of distance d<sound speed c/sampling frequency fs, thus to satisfy the sampling theorem or the Nyquist theorem. Referring to FIG. 1, a broken-line closed pattern represents directivity characteristics or a directivity pattern of the microphone array of MIC1 and MIC2 (a single-direction cardioid directivity). An input sound signal received and converted by the microphone array of MIC1 and MIC2 depends on an incident angle θ (=−π/2 to +π/2) of a sound with respect to a line passing through the microphone array of MIC1 and MIC2 but does not depend on an incident angle (0 to 2π) in a radial direction around the line in a plane vertical to the line. As illustrated in FIG. 1, a unit sphere including the sound reception range Rs, the shift range Rt, and the suppression range Rn is rotationally symmetrical with respect to the line passing through the microphones MIC1 and MIC2.

The microphone MIC2 on the right-hand side in FIG. 1 detects one of a sound and a voice from the target sound source SS later than the microphone MIC1 by a delay time of τ=d/c. The microphone MIC1 on the left-hand side in FIG. 1 detects noise N1 in the main suppression direction later than the microphone MIC2 by the delay time τ=d/c. Noise N2 off-aligned within the suppression range Rn of the main suppression direction is detected by the microphone MIC1 on the left-hand side later by a delay time τ=d·sin θ/c than by the microphone MIC2 on the right-hand side. The angle θ is an incoming direction of the noise N2 which is also assumed to be a suppression direction. As illustrated in FIG. 1, a dot-and-dash chain line represents a wavefront of the noise N2. The incoming direction of the noise N1 with θ=+π/2 is the main suppression direction of the input signal.

In one microphone array, the noise N1 in the main suppression direction (θ=+π/2) is suppressed by subtracting an input signal IN2(t) on the right microphone MIC2 having the delay time of t=d/c from an input signal IN1(t) on the left microphone MIC1. Such a microphone array has difficulty in sufficiently suppressing the noise N2 coming in from a direction (0<θ≦+π/2) off the main suppression direction.

The inventor has learned that the noise N2 in the suppression range Rn of the sound signal is sufficiently suppressed by phase-synchronizing one spectrum of input sound signals of two microphones with the other spectrum on a per frequency basis in accordance with a phase difference between the two input sound signals and by determining a difference between the two spectra.

A target sound source SS′ different from the target sound source SS may appear at a position at a different angle, for example in a direction (θ=0) vertical to the line passing through the microphones MIC1 and MIC2. This means that the mouth of the talker appears or moves there. The limited sound reception range Rs=Rsp is set or modified to an angular range centered to the direction to the target sound source SS′ in one embodiment. Rsp is the limited sound reception range.

The sound reception range and the degree of noise suppression are in a trade-off relationship.

To acquire a sound signal with the noise level thereof reduced, the sound reception range Rs=Rsp with the angular range thereof is limited to an appropriate angular range in one embodiment. The inventor has learned that the noise in the suppression range Rn is sufficiently suppressed if the sound reception range Rs=Rsp limited to a specific direction is determined in response to an appearance of a sound source in the specific direction.

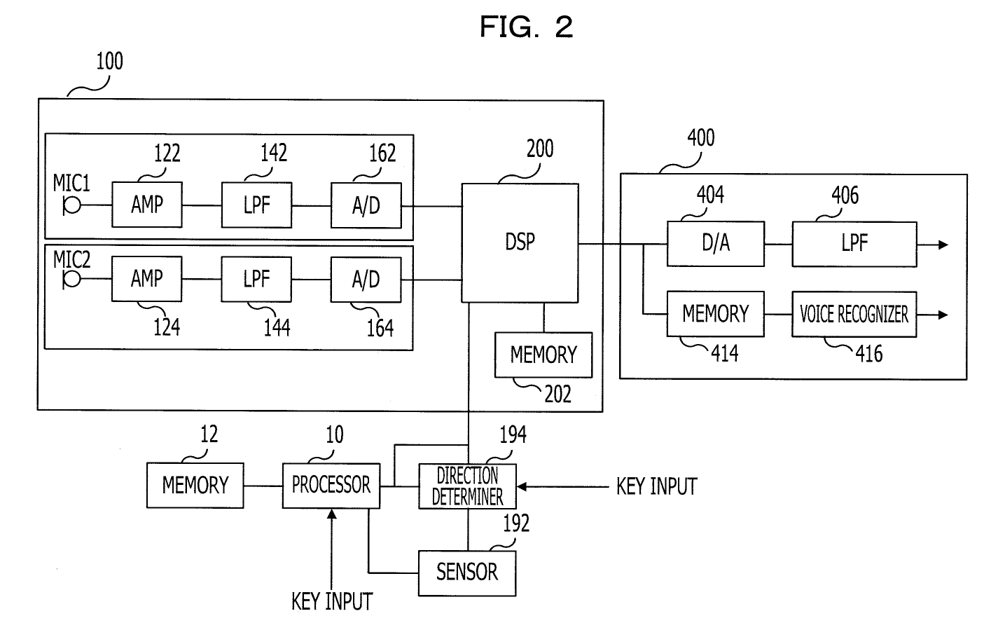

FIG. 2 diagrammatically illustrates a microphone array device 100 of an embodiment including the microphones MIC1 and MIC2 of FIG. 1.

The microphone array device 100 includes a microphone MIC1-101, a microphone MIC2-102, amplifiers (AMP) 122 and 124, low-pass filters (LPF) 142 and 144, analog-to-digital converters (A/D) 162 and 164, digital signal processor (DSP) 200, and memory 202 including a random-access memory (RAM). The microphone array device 100 may be one of information devices including an on-bard device or a car navigation device having a voice recognition function, hands-free telephone, and cellular phone.

The microphone MIC1-101 supplies an output signal ina1 thereof to the amplifier 122. The microphone MIC2-102 supplies an output signal in a2 thereof to the amplifier 124. The amplifier 122 supplies an output signal INa1 thereof to the low-pass filter (LPF) 142. The amplifier 124 supplies an output signal INa2 thereof to the low-pass filter 144. The low-pass filter 142 supplies an output signal INp1 thereof to the analog-to-digital converter 162. The low-pass filter 144 supplies an output signal INp2 thereof to the analog-to-digital converter 164. The analog-to-digital converter 162 supplies an output signal IN1(t) thereof to the digital signal processor 200. The analog-to-digital converter 164 supplies an output signal IN2(t) thereof to the digital signal processor 200.

The microphone array device 100 may be connected to a sensor (a talker direction detection sensor) 192 and a direction determiner 194 or may include the sensor 192 and the direction determiner 194 therewithin. A processor 10 and a memory 12 may be included in a device having an application 400, or may be included in another information processing apparatus. While the microphone array device 100 in illustrated as having two microphones in FIG. 2, the present invention is not limited to any particular number of microphones.

The talker direction detection sensor 192 may be a digital camera, an ultrasonic sensor, or an infrared sensor. The direction determiner 194 may be mounted on the processor 10 that operates in accordance with a direction determination program stored on the memory 12.

The analog input signal ina1 into which the microphone MIC1-101 has converted a sound is supplied to the amplifier 122 and then amplified by the amplifier 122. The analog input signal in a2 into which the microphone MIC2-102 has converted a sound is supplied to the amplifier 124 and then amplified by the amplifier 124. The analog sound signal INa1 as the output of the amplifier 122 is supplied to an input of the low-pass filter 142, and then low-pass filtered for sampling later. The analog sound signal INa2 as the output of the amplifier 124 is supplied to an input of the low-pass filter 144, and then low-pass filtered for sampling later. The low-pass filters only are used here. Alternatively, a band-pass filter may be substituted for the low-pass filter. Furthermore, the band-pass filter may be used together with a high-pass filter. The cutoff frequency fc of the low-pass filters 142 and 144, for example, may be 3.9 kHz.

The analog signal INp1 output by the low-pass filter 142 is supplied to an input of the analog-to-digital converter 162 and converted to a digital input signal. The analog signal INp2 output by the low-pass filter 144 is supplied to an input of the analog-to-digital converter 164 and converted to a digital input signal. The digital input signal IN1(t) in the time domain output by the analog-to-digital converter 162 is supplied to a sound signal input terminal or a sound signal input unit it1 of the digital signal processor 200. The digital input signal IN2(t) in the time domain output by the analog-to-digital converter 164 is supplied to a sound signal input terminal or a sound signal input unit it2 of the digital signal processor 200. A sampling frequency fs of the analog-to-digital converters 162 and 164 may be 8 kHz (fs>2 fc).

Together with the memory 202, the digital signal processor 200 converts the digital input signal IN1(t) in the time domain into a digital input signal in the frequency domain or a complex spectrum IN1(f) through Fourier transform. The digital signal processor 200 converts the digital input signal IN2(t) in the time domain into a digital input signal in the frequency domain or a complex spectrum IN2(f) through Fourier transform. The digital signal processor 200 further processes the digital input signal IN1(f) to suppress noise N1 in the suppression range Rn of noise. The digital signal processor 200 further processes the digital input signal IN1(f) to suppress noise N2 in the suppression range Rn of noise. The digital signal processor 200 inverse-converts the processed digital input signal INd(f) in the frequency domain into a digital sound signal INd(t) in the time domain through inverse Fourier transform, thereby generating a noise-suppressed digital sound signal INd(t).

The digital signal processor 200 sets a maximum sound reception range Rs=Rsmax, a shift range Rt=Ri, and a minimum suppression range Rn=Rnmin. The digital signal processor 200 then processes the complex spectra IN1(f) and IN2(f) of all frequencies f or a frequency f within a particular bandwidth, thereby determining a direction θss of the target sound source SS or SS′ in the sound reception range Rsmax or a phase difference DIFF(f) representing the direction Ess. The digital signal processor 200 then determines or estimates a coefficient D(f) of a frequency f in the phase difference DIFF(f) (=D(f)xf) as a linear function of frequency. The frequency f in the particular bandwidth may be within a frequency band including a frequency having maximum power or a frequency having a relatively high S/N ratio, for example, within a range of f=0.5 to 1.5 kHz near f=1 kHz.

The digital signal processor 200 determines the limited sound reception range Rs=Rsp in accordance with the determined direction Ess or the coefficient D(f), and sets the shift range Rt adjacent to Rsp and the remaining suppression range Rn. The digital signal processor 200 processes the complex spectra IN1(f) and IN2(f) on a per frequency f basis, suppresses the noises N1 and N2 in the suppression range Rn and the shift range Rt, and generates a processed digital input signal INd(f). The directivity of the microphone array device 100 is relatively enhanced with respect to the target sound source.

The microphone array device 100 is applicable to an information processing apparatus such as a car navigation device having a voice recognition function and other similar apparatuses. Pre-set on the microphone array device 100 may be the incoming direction Ess of the main target sound source SS, and the incoming direction of a voice of a driver, and a maximum sound reception range Rsmax of the voice of the driver.

The digital signal processor 200 may be connected to one of the direction determiner 194 and the processor 10 as previously described. In such a case, the digital signal processor 200 receives from one of the direction determiner 194 and the microphone array device 100 information representing a direction Od to the talker or a maximum sound reception range Rsmax. In response to the information representing the direction Od to the talker or the maximum sound reception range Rsmax, the digital signal processor 200 sets the maximum sound reception range Rs=Rsmax, the shift range Rt=Rti, and the minimum suppression range Rn=Rnmin in the initial set state.

One of the direction determiner 194 and the processor 10 may generate the information representing the maximum sound reception range Rsmax by processing a set signal entered through key inputting by a user. One of the direction determiner 194 and the processor 10 may detect or recognize the presence of the talker in response to data or image data detected by the talker direction detection sensor 192, and then determine the direction Od to the talker and generate the information representing the maximum sound reception range Rsmax.

The digital sound signal INd(t) output by the digital signal processor 200 may be used in voice recognition or communications between cellular phones. The digital sound signal INd(t) may be supplied to the application 400. A digital-to-analog converter 404 converts the digital sound signal INd(t) into an analog signal, and a low-pass filter 406 filters the analog signal. A filtered analog signal is thus generated. In the application 400, the digital sound signal INd(t) is stored on a memory 414 and then used by a voice recognizer 416 in voice recognition. The voice recognizer 416 may be a processor implemented as a hardware element, or a processor operating in accordance with a software program stored on the memory 414 including a ROM or a RAM.

The digital signal processor 200 may be a signal processing circuit implemented as a hardware element, or a signal processing circuit operating in accordance with a software program stored on the memory 202 including a ROM or a RAM.

As illustrated in FIG. 1, the microphone array device 100 may set a limited angular range centered on at the direction θss (=−π/2) to the target sound source SS to be the sound reception range or the non-suppression range Rs=Rsp. The microphone array device 100 may set an angular range centered on at the main suppression direction θ=+π/2 to be the suppression range Rn. In an alternative embodiment, the direction θss of the target sound source SS and the main suppression direction θ illustrated in FIG. 1 may be laterally reversed in position. In such a case, the microphones MIC1 and MIC2 are also laterally reversed in position.

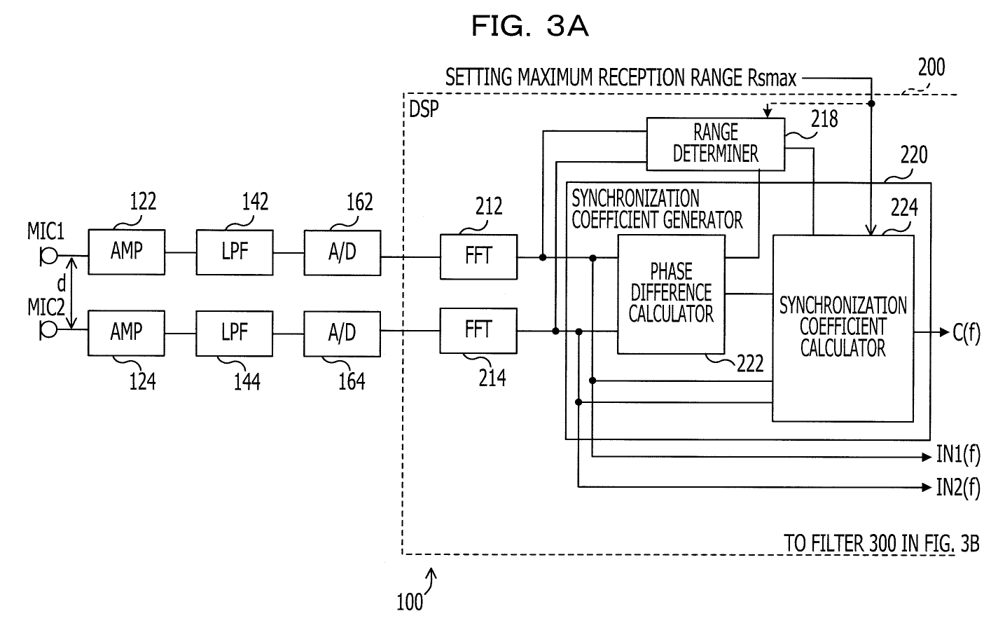

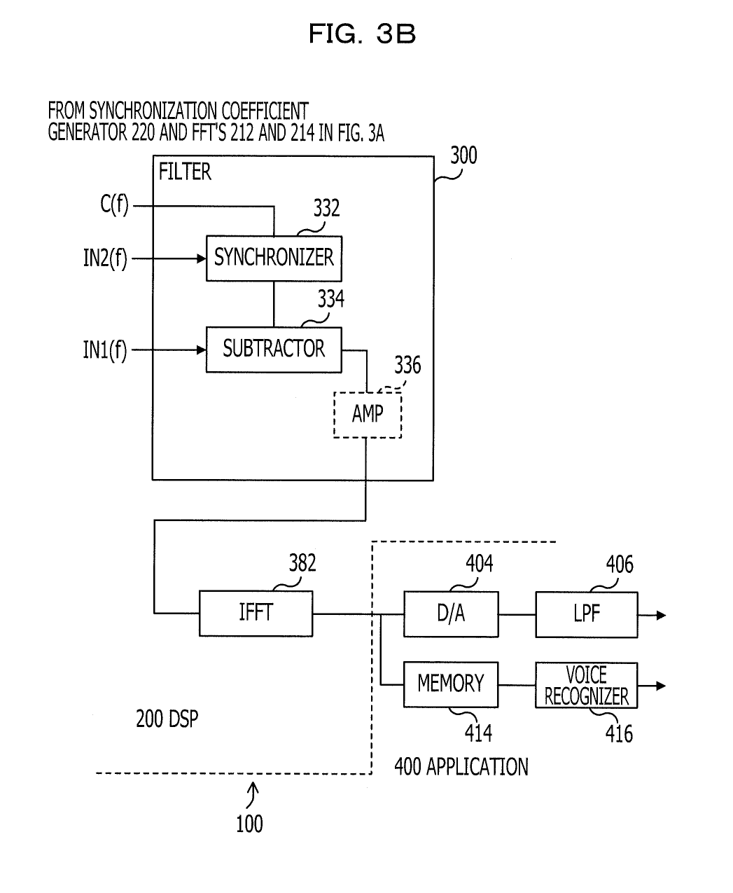

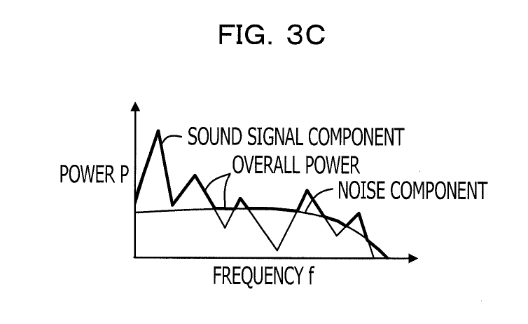

The synchronization coefficient generator 220 illustrated in FIG. 3 sets a maximum sound reception range (Rsmax) equal to −π/2≦θ≦+0 as a maximum sound reception range Rs, a shift range (Rti) equal to ±0<θ≦+π/6 as a shift range Rt, and a minimum suppression range (Rnmin) equal to +π/6<θ≦+π/2 as a minimum suppression range Rn.

If the direction ess of the target sound source SS appears close to a direction θ=−π/2 as the statistical mean value or the smoothed value on the frequency f, the sound reception range Rs may be set to be a limited angular range Rsp such as −π/2≦θ≦−π/4. The noises N1 and N2 are thus suppressed sufficiently. If the direction ess of the target sound source SS′ appears close to a direction θ=±0 as the statistical mean value on the frequency f, the sound reception range Rs may be set to be a limited angular range Rsp such as −π/9≦θ≦+π/9. The noises N1 and N2 are suppressed sufficiently.

FIGS. 3A and 3B illustrate a general functional structure of the microphone array device 100 that reduces noise by suppressing noise with the array of the microphones MIC1 and MIC2 of FIG. 1.

The digital signal processor 200 includes a fast Fourier transformer (FFT) 212 having an input connected to an output of the analog-to-digital converter 162 and a fast Fourier transformer 214 having an input connected to an output of the analog-to-digital converter 164. The digital signal processor 200 further includes a range determiner 218, a synchronization coefficient generator 220, and a filter 300. The range determiner 218 may also be considered as having a function as a sound reception range determiner or a suppression range determiner. According to an embodiment, fast Fourier transform is used for frequency transform or orthogonal transform. Alternatively, another function for frequency transform, such as discrete cosine transform, or wavelet transform, may be used.

The fast Fourier transformer 212 supplies an output signal IN1(f). The fast Fourier transformer 214 supplies an output signal IN2(f). The range determiner 218 supplies output signals D(f) and Rs to a synchronization coefficient calculator 224. A phase difference calculator 222 supplies an output signal DIFF(f). The synchronization coefficient calculator 224 supplies an output signal C(f) to a synchronizer 332. The synchronizer 332 supplies an output signal INs2(f) to a subtractor 334. The subtractor 334 supplies an output signal INd(f). An inverse fast Fourier transformer 382 supplies an output signal INd(t). In the phase difference calculator 222 and the synchronization coefficient calculator 224, a condition f<fc or f<c/2d holds, for example.

The synchronization coefficient generator 220 includes the phase difference calculator 222. The phase difference calculator 222 calculates a phase difference DIFF(f) between complex spectra of each frequency f (0<f<fs/2) in a frequency bandwidth such as an audible frequency bandwidth. The synchronization coefficient generator 220 further includes the synchronization coefficient calculator 224. The filter 300 includes the synchronizer 332 and the subtractor 334. Optionally, the filter 300 may also include an amplifier (AMP) 336. The subtractor 334 may be replaced with a substitute circuit including a sign inverter inverting an input value and an adder connected to the sign inverter. In an alternative embodiment, the range determiner 218 may be included in one of the synchronization coefficient generator 220 and the synchronization coefficient calculator 224.

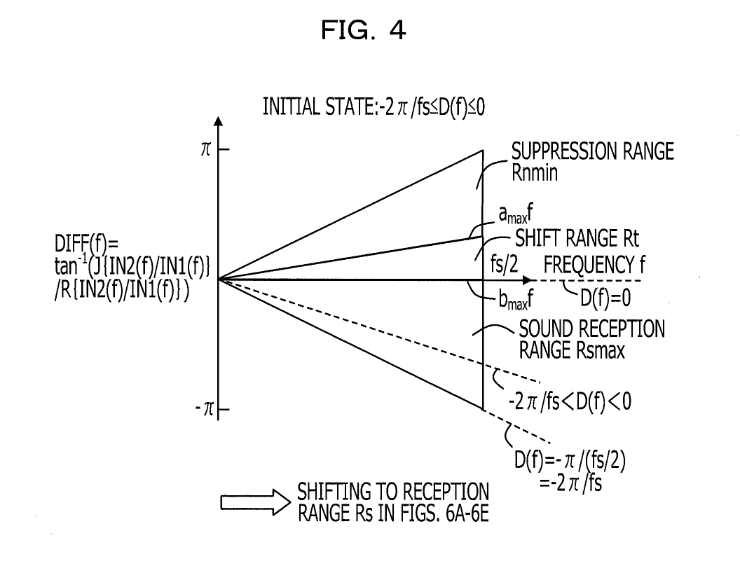

The range determiner 218 has inputs connected to the outputs of the two fast Fourier transformers 212 and 214, and the output of the phase difference calculator 222. The phase difference DIFF(f) is represented by a linear function DIFF(f)=D(f)×f of the frequency f. Here, D(f) is a coefficient of a frequency variable f of the linear function of frequency, and represents a gradient or a proportional constant. The synchronization coefficient generator 220 generates the phase difference DIFF(f) of the maximum sound reception range Rsmax in the initial set state (FIG. 4), and then supplies the phase difference DIFF(f) to the range determiner 218. In response to the input complex spectra IN1(f) and IN2(f), the range determiner 218 generates, in the phase difference DIFF(f) input from the synchronization coefficient generator 220, the gradient D(f) that is a statistical mean value or an average value related to the frequency f. The gradient D(f) is represented by the following equation:

D(f)=Σf×DIFF(f)/Σf²

The bandwidth of the frequency f may be 0.3-3.9 kHz. The range determiner 218 may determine the sound reception range Rs, the suppression range Rn, and the shift range Rt in response to the gradient D(f).

The range determiner 218 may determine the phase difference DIFF(f) and the gradient D(f) at a frequency f where a portion of each of the complex spectra IN1(f) and IN2(f) has a power spectral component higher than a power spectral component N of estimated noise N. The power spectrum refers to the square of the absolute value of an amplitude of a complex spectrum at different frequencies or the power of a complex spectrum at different frequencies. The range determiner 218 may determine noise power at each frequency f in the power spectrum representing a pattern of silence in response to the input complex spectra IN1(f) and IN2(f). The range determiner 218 may thus estimate the resulting noise power as steady noise power N.

FIG. 3C illustrates a relationship between a power spectrum in a sound signal segment of a target sound source, and a power spectrum of a noise segment. The power spectrum of a sound signal or a voice signal of a target sound source is relatively regular but not uniform in distribution. On the other hand, the power spectrum in the steady noise segment is relatively irregular but generally regular in distribution over the entire frequency range. The sound signals of the target sound sources SS and SS′ and the steady noise N may be identified based on such a distribution difference. Pitch (harmonics) characteristics unique to a voice or a formant distribution of the voice may be identified to identify the sound signals of the target sound sources SS and SS′ and the steady noise N.

Power P1 of the complex spectrum IN1(f) and power P2 of the complex spectrum IN2(f) typically satisfy P1≧P2+ΔP (ΔP is an error tolerance determined by a design engineer) with respect to the phase difference DIFF(f) in the maximum sound reception range Rsmax. This is because one of the target sound sources SS and SS′ is closer to the microphone MIC1 than to the microphone MIC2 or is substantially equidistant to the microphones MIC1 and MIC2. The phase difference DIFF(f) failing to satisfy P1≧P2+ΔP may be determined and then excluded in addition to or in place of the determination of the estimated noise power N.

An appropriate phase difference DIFF(f) of the sound signal of the target sound sources SS and SS′ in the maximum sound reception range Rsmax and the gradient D(f) of the phase difference DIFF(f) are determined by the determination of the estimated noise power N and/or by the comparison of the complex spectra IN1(f) and IN2(f). The phase difference resulting from the noises N1 and N2 is thus excluded as much as possible.

The phase difference calculator 222 determines the phase difference DIFF(f) between the complex spectra IN1(f) and IN2(f) of all frequencies f or of the frequency f within a particular bandwidth from the fast Fourier transformers 212 and 214 as will be described below. In an alternative embodiment, the range determiner 218 may operate in the same way as the synchronization coefficient generator 220, and thus may determine the phase difference DIFF(f) between the complex spectra IN1(f) and IN2(f) of all frequencies f or of the frequency f within a particular bandwidth from the fast Fourier transformers 212 and 214.

The gradient D(f) corresponds to an angular direction θ (=θss) of a dominant or central sound source, such as the target sound source SS or SS′. The relationship between the gradient D(f) and the angular direction θ is represented by D(f)=(4/fs)×θ or θ=(fs/4)×D(f).

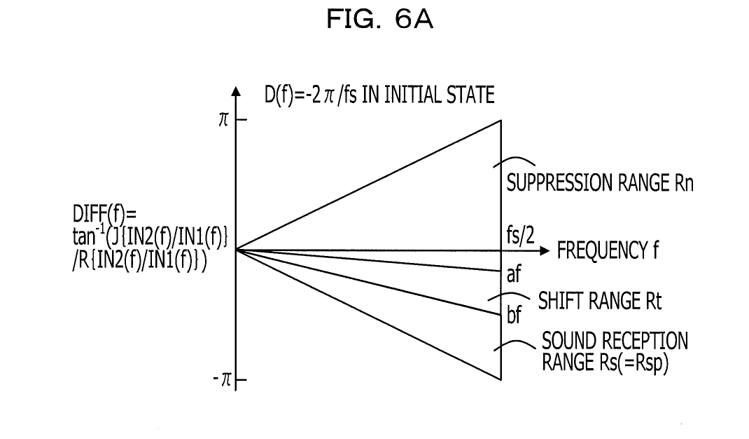

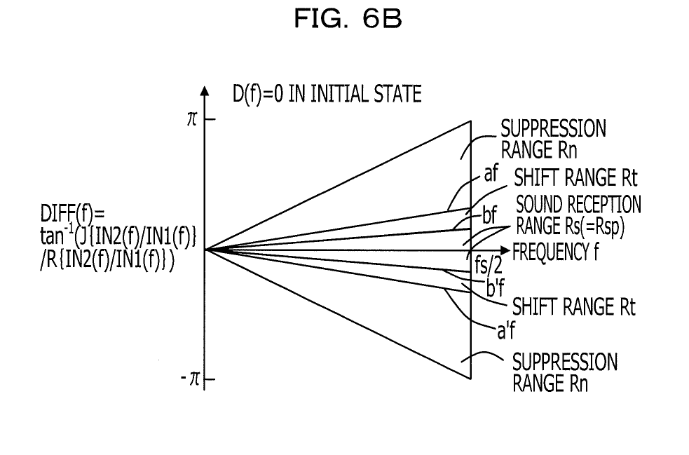

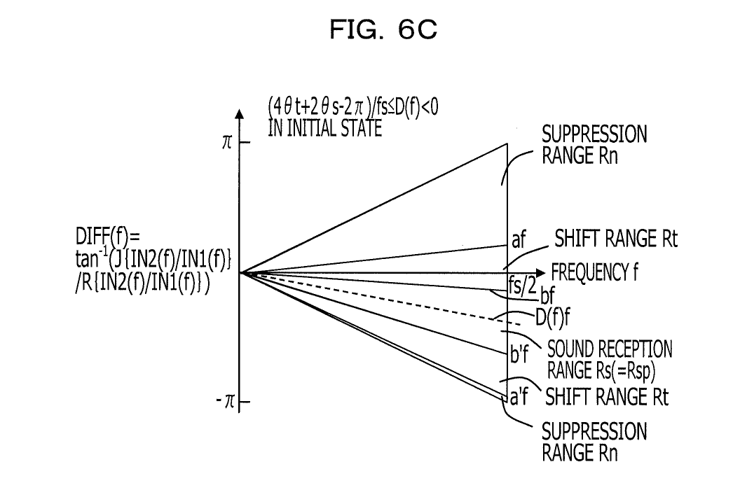

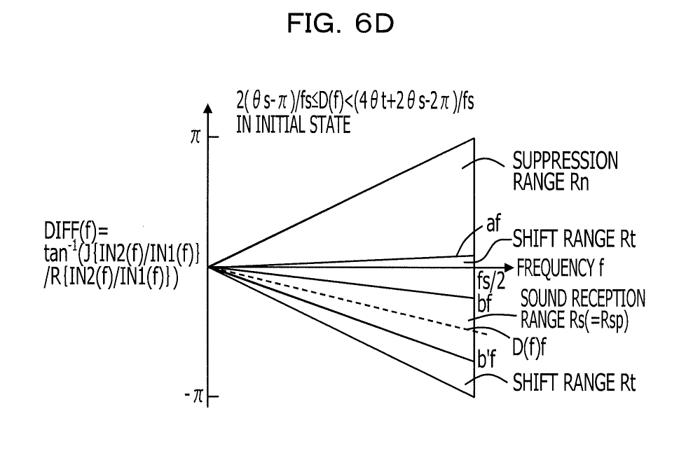

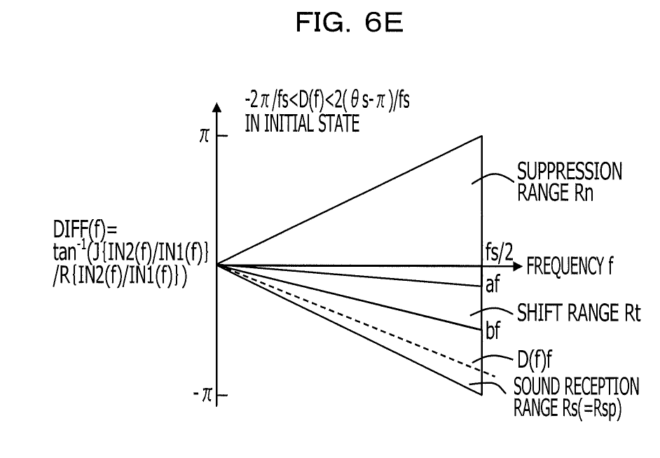

The range determiner 218 supplies to the synchronization coefficient calculator 224 data representing the gradient D(f) and/or phase difference data (border coefficients a, a′, b, and b′ in FIGS. 6A-6E) representing the limited sound reception range Rs=Rsp corresponding to the gradient D(f). The synchronization coefficient calculator 224 may determine the sound reception range Rs=Rsp, the suppression range Rn, and the shift range Rt in accordance with the gradient D(f).

FIG. 4 illustrates a relationship the phase difference DIFF(f) for the phase spectral component of each frequency f calculated by the phase difference calculator 222 in accordance with the arrangement of the microphones MIC1 and MIC2 of FIG. 1, the maximum sound reception range Rs=Rsmax, the shift range Rt=Rti, and the suppression range Rn=Rnmin in the initial set state.

The phase difference DIFF(f) falls within a range of −2π/fs<DIFF(f)<+2π/fs, and the frequency f is a function represented by −(2π/fs)f≦DIFF(f)≦+(2π/fs). If the maximum sound reception range Rsmax in the initial set state is −π/2≦θ≦±0, the gradient D(f) falls within a range of −(2π/fs)≦D(f)≦±0. If the angular direction θss of the target sound source SS is θss=−π/2 on all frequencies f, the gradient D(f)=−π/(fs/2)=−2π/fs. The angular direction of the target sound source SS is θss=0 on all frequencies f, the gradient D(f)=0.

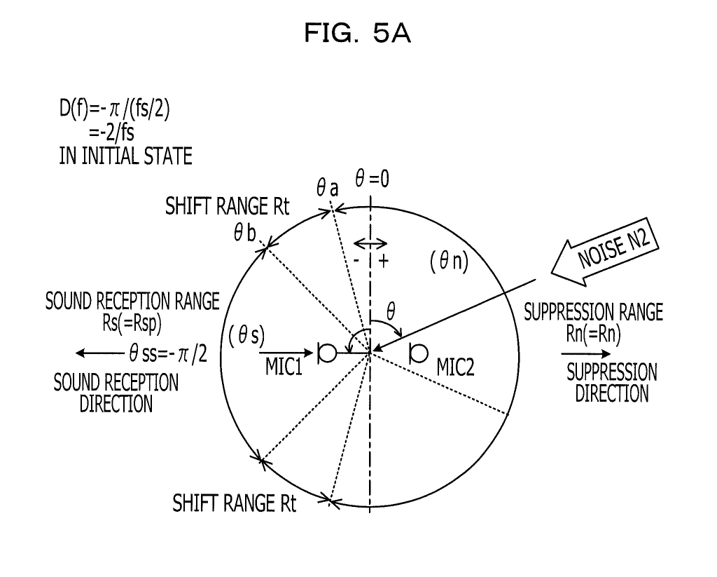

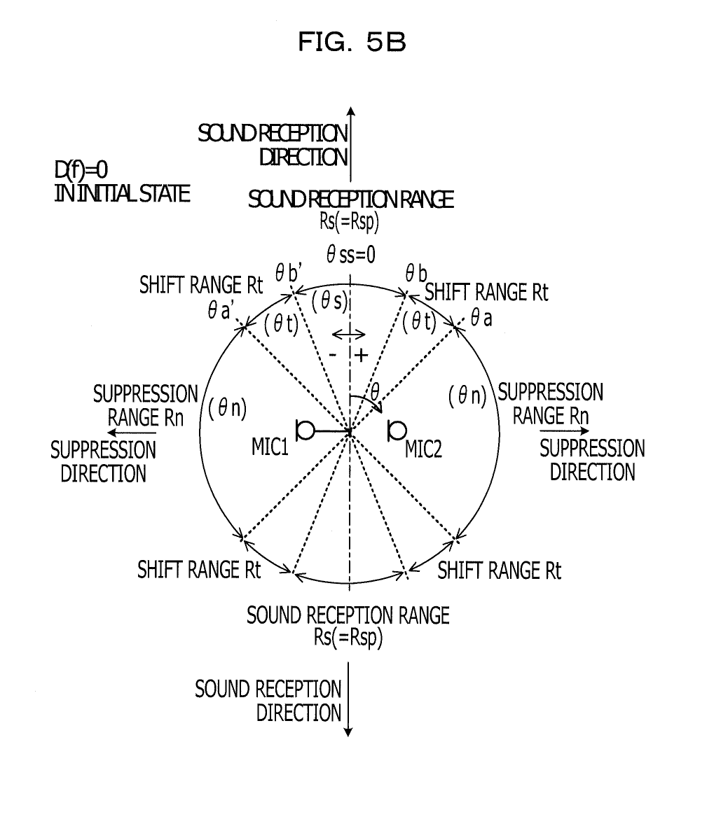

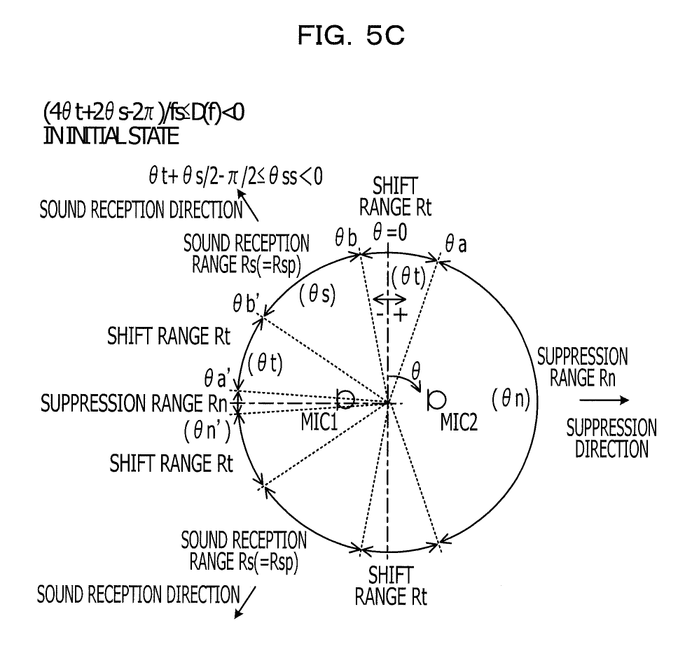

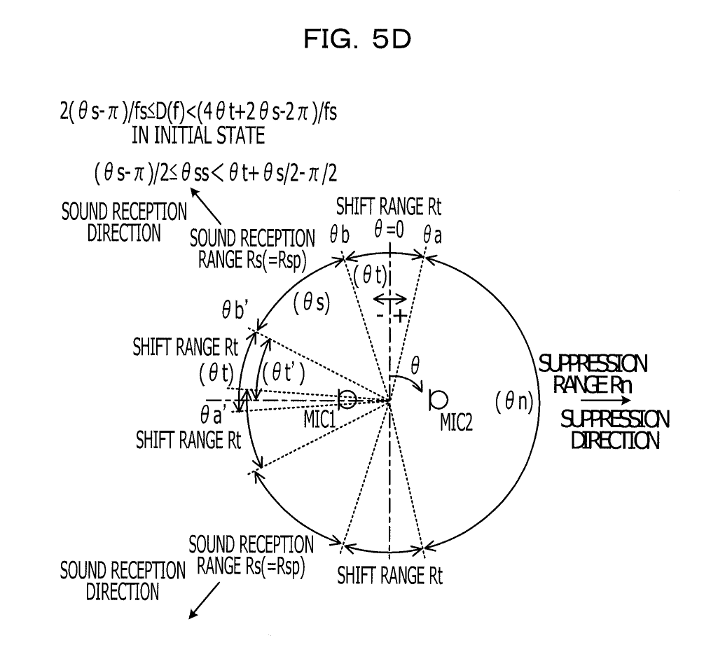

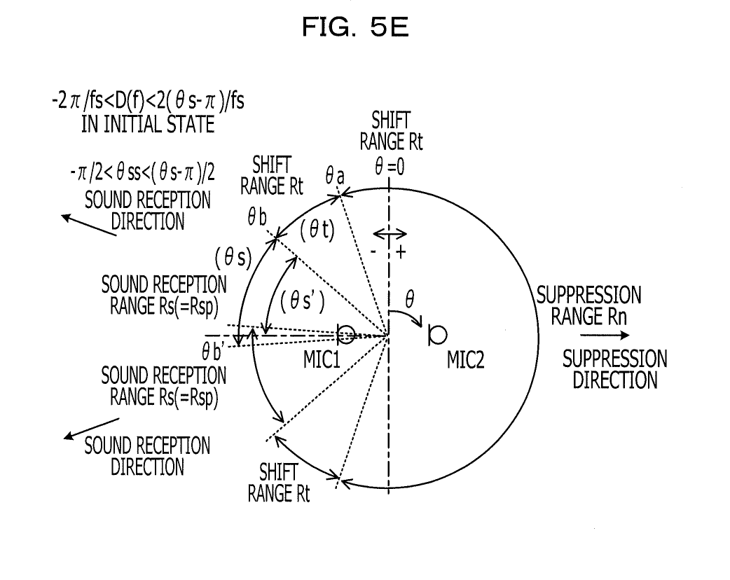

FIG. 5A illustrates a set state of the limited sound reception range Rs=Rsp, the shift range Rt and the suppression range Rn in response to the statistical mean value or the smoothed value of the gradient D(f)=−2π/fs of the phase difference DIFF(f) in a sound reception range limited state.

FIG. 5B illustrates a set state of the limited sound reception range Rs=Rsp, the shift range Rt and the suppression range Rn at another gradient D(f)=0 in the sound reception range limited state.

FIG. 5C illustrates a set state of the limited sound reception range Rs=Rsp, the shift range Rt and the suppression range Rn at another gradient D(f) falling within a range of (4θt+2θs−2π)/fs<D(f)<0 in the sound reception range limited state.

FIG. 5D illustrates a set state of the limited sound reception range Rs=Rsp, the shift range Rt and the suppression range Rn at another gradient D(f) falling within a range of 2(θs−π)/fs<D(f)<(4θt+2θs−2π)/fs in the sound reception range limited state.

FIG. 5E illustrates a set state of the limited sound reception range Rs=Rsp, the shift range Rt and the suppression range Rn at another gradient D(f) falling within a range of −2π/fs<D(f)<2(θs−π)/fs in the sound reception range limited state. In FIGS. 5A, 5B, 5C, 5D and 5E (5A-5E), θs and θs′ represent angular ranges of sound reception, θt and θt′ represent angular ranges of shift, and θn and θn′ represent angular ranges of sound suppression.

As illustrated in FIG. 5A, if the gradient D(f) is D(f)=−2π/fs in the initial set state, the synchronization coefficient calculator 224 sets the limited sound reception range Rs(θ)=Rsp to be a minimum −π/2≦θ≦b=θs/2−π/2. The synchronization coefficient calculator 224 then sets the shift range Rt(θ) to be θb=θs/2−π/2<θ≦θa=θs/2+θt−π/2. The synchronization coefficient calculator 224 then sets the suppression range Rn(e)(=Rnmax) to be the remaining θa=θs/2+θt−π/2<θ≦+π/2. The angle es of the sound reception range Rs may be a value falling within a range of θs=π/3 to π/6. Then angle et of the shift range Rt may be a value falling within a range of θt=π/6 to π/12.

If the gradient D(f) is D(f)=0 in the initial set state as illustrated in FIG. 5B, the synchronization coefficient calculator 224 sets the limited sound reception range Rs(θ)=Rsp to be θb′=−θs/2≦θ≦θb=+θs/2. The synchronization coefficient calculator 224 then sets the shift range Rt(θ) to be θb=θs/2<θ≦θa=θs/2+θt and θa′=−θs/2−θt<θ≦θb′=−θs/2. The synchronization coefficient calculator 224 then sets the suppression range Rn(θ) to be the remaining θa=θs/2+θt<θ≦+π/2 and −π/2≦θ<θa′=−θs/2−θt.

If the gradient D(f) falls within a range of (4θt+2θs−2π)/fs≦D(f)<0 in the initial set state as illustrated in FIG. 5C, the synchronization coefficient calculator 224 sets the limited sound reception range Rs(θ)=Rsp to be θb′≦θ≦θb. The synchronization coefficient calculator 224 then sets the shift range Rt(θ) to be θb<θ≦θa and θa′<θ≦θb′. The synchronization coefficient calculator 224 then sets the suppression range Rn(e) to be the remaining θa<θ≦+π/2 and −π/2≦θ<θa′.

If the gradient D(f) falls within a range of 2(θs−π)/fs≦D(f)<(4θt+2θs−2π)/fs in the initial set state as illustrated in FIG. 5D, the synchronization coefficient calculator 224 sets the limited sound reception range Rs(θ)=Rsp to be θb′≦θ≦θb. The synchronization coefficient calculator 224 then sets the shift range Rt(θ) to be θb<θ≦θa and −π/2≦θ<θb′. The synchronization coefficient calculator 224 then sets the suppression range Rn(θ) to be the remaining θa<θ≦+π/2 and −π/2≦θ<θa′.

If the gradient D(f) falls within a range of −2π/fs<D(f)<2(θs−π)/fs in the initial set state as illustrated in FIG. 5E, the synchronization coefficient calculator 224 sets the limited sound reception range Rs(θ)=Rsp to be −π/2≦θ≦θb. The synchronization coefficient calculator 224 then sets the shift range Rt(θ) to be θb<θ≦θa. The synchronization coefficient calculator 224 then sets the suppression range Rn(θ) to be the remaining θa<θ≦+π/2.

In one embodiment, the sound reception range Rs, the suppression range Rn, and the shift range Rt are controlled as illustrated in FIGS. 5A-5E such that the noise suppression quantity with reference to the sound of the target sound source is generally and substantially constant regardless of the angular direction θss of the target sound source.

The angle θs of the limited sound reception range Rs may be set to be variable with respect to any center angular direction θss such that the sum of solid angles of the limited sound reception range Rs=Rsp (an overall occupied surface area on the unit sphere) is substantially constant as in FIGS. 5A-5E. Similarly, the angle θn of the suppression range Rn may be set to be variable with respect to any border angular direction θa and θa′ such that the sum of solid angles of the suppression range Rn is substantially constant. Similarly, the angle θt of the shift range Rt may be set to be variable with respect to border angular directions θa, θa′, θb, and θb′ such that the sum of noise power components is substantially constant. Generally, the angle θt of the shift range Rt may be set to be variable with respect to border angular directions θa, θa′, θb, and θb′ such that the sum of solid angles of the shift range Rt is substantially constant. The angle θs may be set to be variable such that the magnitude (width) of the angle θs of the sound reception range Rs gradually decreases as the angular direction θss increases from −π/2 to 0. The angle θn may be set to be variable such that the magnitude (width) of the angle θn of the suppression range Rn gradually decreases as the angular direction θss increases from −π/2 to 0. The angles θs, θn, and θt may be determined in response to the angular direction θss based on measured values.

The angle θs of the limited sound reception range Rs may be set to be variable with respect to any center angular direction θss such that the sum of solid angles of the limited sound reception range Rs is substantially constant. In such a case, the case of FIG. 5E may be represented in FIG. 5A. In FIG. 5A, the angular direction θss of the target sound source SS is applicable to a range of −π/2≦θss≦(θs−π)/2.

In place of the synchronization coefficient calculator 224, the range determiner 218 may set the sound reception range Rs, the shift range Rt, and the suppression range Rn illustrated in FIGS. 5A-5E to the synchronization coefficient calculator 224.

Operation of the digital signal processor 200 is described more specifically.

The digital input signal IN1(t) in the time domain from the analog-to-digital converter 162 is supplied to the fast Fourier transformer 212. The digital input signal IN2(t) in the time domain from the analog-to-digital converter 164 is supplied to the fast Fourier transformer 214. In a known technique, the fast Fourier transformer 212 multiplies the digital input signal IN1(t) in each signal segment by an overlap window function, and Fourier transforms or orthogonal transforms the resulting product to generate a complex spectrum IN1(f) in the frequency domain. In the known technique, the fast Fourier transformer 214 multiplies the digital input signal IN2(t) in each signal segment by an overlap window function, and Fourier transforms or orthogonal transforms the resulting product to generate a complex spectrum IN2(f) in the frequency domain. IN1(f)=A₁e^{j(2πft+φ1(f))}, and IN2(f)=A₂e^{(j(2πft+φ2(f))} where f represents frequency, A₁ and A₂ represent amplitudes, j represents a unit imaginary number, and φ1(f) and φ2(f) represent phase delays. The overlap window functions include hamming window function, hanning window function, Blackman window function, 3 sigma Gaussian window function, and triangular window function.

The phase difference calculator 222 determines the phase difference DIFF(f) (radians) of the phase spectral component indicating the sound source direction on a per frequency f basis (0<f<fs/2) between the two adjacent microphones MIC1 and MIC2 spaced by the distance d in accordance with the following equation:

DIFF(f)=tan⁻¹(J{IN2(f)/IN1(f)}/R{IN2(f)/IN1(f)})

It is assumed here that a single sound source corresponds to a single frequency f. J{x} represents an imaginary part of a complex number x and R{x} represents a real part of the complex number x.

The phase difference DIFF(f) is expressed in delayed phase (φ1(f), φ2(f)) of the digital input signals IN1(t) and IN2(t) as follows:

$$\begin{matrix}DIFF ( f ) = {tan}^{- 1} ( J \{ \frac{{A}_{2} {e}^{j ( 2 π f t + φ 2 ( f ) )}}{{A}_{1} {e}^{j ( 2 π f t + φ 1 ( f ) )}} \} / R \{ \frac{{A}_{2} {e}^{j ( 2 π f t + φ 2 ( f ) )}}{{A}_{1} {e}^{j ( 2 π f t + φ 1 ( f ) )}} \} ) \\ = {tan}^{- 1} ( J \{ ( {A}_{2} / {A}_{1} ) {e}^{j ( φ 2 ( f ) - φ1 ( f ) )} \} / R \{ ( {A}_{2} / {A}_{1} ) {e}^{j ( φ 2 ( f ) - φ1 ( f ) )} \} ) \\ = {tan}^{- 1} ( J \{ {e}^{j ( φ2 ( f ) - φ1 ( f ) )} \} / R \{ {e}^{j ( φ2 ( f ) - φ1 ( f ) )} \} ) \\ = {tan}^{- 1} ( sin ( φ2 ( f ) - φ1 ( f ) ) / cos ( φ2 ( f ) - φ1 ( f ) ) ) \\ = {tan}^{- 1} ( tan ( φ2 ( f ) - φ1 ( f ) ) ) \\ = φ2 ( f ) - φ1 ( f )\end{matrix}$$

where the input signal IN1(t) from the microphone MIC1 serves as a comparison reference out of the input signals IN1(t) and IN2(t). If the input signal IN2(t) from the microphone MIC2 serves as a comparison reference, the input signals IN1(t) and IN2(t) are simply substituted for each other.

The phase difference calculator 222 may supply to the synchronization coefficient calculator 224 the value of the phase difference DIFF(f) of the phase spectral component on a per frequency f basis between the two adjacent input signals IN1(f) and IN2(f). The phase difference calculator 222 may also supply the value of the phase difference DIFF(f) to the range determiner 218.

FIGS. 6A, 6B, 6C, 6D and 6E (6A-6E) illustrate relationships of the phase difference DIFF(f) of a phase spectral component of each frequency f with respect to different gradients D(f), the limited sound reception range Rs=Rsp, the shift range Rt, and the suppression range Rn in the limited sound reception range state. The phase differences DIFF(f) of FIGS. 6A-6E respectively correspond to the angular directions θ of FIG. 5A-5E.

Referring to FIGS. 6A-6E, linear functions of and a′f represent border lines of the phase difference DIFF(f) corresponding to the angular border lines θa and θa′ between the suppression range Rn and the shift range Rt, respectively. The frequency f falls within a range of 0<f<fs/2. Represented by a and a′ are coefficients of the frequency f. Linear functions bf and b′f represent border lines of the phase difference DIFF(f) corresponding to the angular border lines θb and θb′ between the sound reception range Rs=Rsp and the shift range Rt, respectively. Represented by b and b′ are coefficients of the frequency f. Here, a, a′, b and b′ satisfy the relationship of a>b, and b′<a′.

If D(f)=−2π/fs as in FIG. 6A, the sound reception range Rs (DIFF(f))=Rsp is set to be −2π/fs≦DIFF(f)≦bf=2(θs−π)f/fs. The shift range Rt(DIFF(f)) is set to be bf=2(θs−π)f/fs<θ≦af=(2θs+4θt−2π)f/fs. The suppression range Rn(DIFF(f)) is set to be af=(2θs+4θt−2π)f/fs<DIFF(f)≦+2πf/fs.

If D(f)=0 as in FIG. 6B, the sound reception range Rs (DIFF(f))=Rsp is set to be b′f=−2θsf/fs≦DIFF(f)≦bf=+2θsf/fs. The shift range Rt(DIFF(f)) is set to be bf=2θsf/fs<DIFF(f)≦af=(2θs+4θt)f/fs, and a′f=(−2θs−4θt)f/fs<DIFF(f)≦b′f=−2θsf/fs. The suppression range Rn(DIFF(f)) is set to be af=(2θs+4θt)f/fs<DIFF(f)≦+2πf/fs and −2πf/fs≦DIFF(f)<a′f=(−2θs−4θt)f/fs.

If the gradient D(f) falls within a range of (4θt+2θs−2π)/fs≦D(f)<0 as in FIG. 6C, the sound reception range Rs (DIFF(f))=Rsp is set to be b′f=(D(f)−2θs/fs)f≦DIFF(f)≦bf=(D(f)+2θs/fs)f. The shift range Rt(DIFF(f)) is set to be bf<DIFF(f)≦af=(D(f)+(2θs+4θt)/fs)f, and a′f=(D(f)−(2θs+4θs)/fs)f<DIFF(f)≦b′f. The suppression range Rn(DIFF(f)) is set to be af<DIFF(f)≦+2πf/fs and −2πf/fs≦DIFF(f)<a′f=(−2θs−4θt)f/fs.

If the gradient D(f) falls within a range of 2(0t−π)/fs≦D(f)<(4θt+2θs−2π)/fs as in FIG. 6D, the sound reception range Rs (DIFF(f))=Rsp is set to be b′f=≦DIFF(f)≦bf. The shift range Rt(DIFF(f)) is set to be bf<DIFF(f)≦af and −2πf/fs≦DIFF(f)≦b′f. The suppression range Rn(DIFF(f)) is set to be af<DIFF(f)≦+2πf/fs.

If the gradient D(f) falls within a range of −2π/fs<D(f)<2(θs−π)/fs as in FIG. 6E, the sound reception range Rs (DIFF(f))=Rsp is set to be −2π/fs≦DIFF(f)≦bf. The shift range Rt(DIFF(f)) is set to be bf<DIFF(f)≦af. The suppression range Rn(DIFF(f)) is set to be af<DIFF(f)≦+2πf/fs. The angle θs of the limited sound reception range Rs may be set to be variable with respect to any center angular direction θss such that the sum of solid angles of the limited sound reception range Rsp is substantially constant. In such a case, the case of FIG. 6E may be represented in FIG. 6A. FIG. 6A is applicable to the gradient D(f) falling within a range of −2π/fs≦D(f)<2(θs−π)/fs.

If the phase difference DIFF(f) falls within the range corresponding to the suppression range Rn in FIGS. 6A-6E, the synchronization coefficient calculator 224 performs a noise suppression process on the digital input signals IN1(f) and IN2(f). If the phase difference DIFF(f) falls within the range corresponding to the shift range Rt, the synchronization coefficient calculator 224 performs on the digital input signals IN1(f) and IN2(f) the noise suppression process at a level that is lowered in response to the frequency f and the phase difference DIFF(f). If the phase difference DIFF(f) falls within the range corresponding to the sound reception range Rs=Rsp, the synchronization coefficient calculator 224 does not performs the noise suppression process on the digital input signals IN1(f) and IN2(f).

The synchronization coefficient calculator 224 estimates that the noise in the input signal at the frequency f having arrived at the microphone MIC1 at the angle θ within the suppression range Rn is the same as the noise in the input signal to the microphone MIC2 but has arrived with a delay of the phase difference DIFF(f). The angle θ within the suppression range Rn may be −π/12<θ≦+π/2, +π/9<θ≦+π/2, +2π/9<θ≦+π/2 and −π/2≦θ<−2π/9. If the angle θ within the suppression range Rn is negative, for example within −π/2≦θ<−2π, the phase difference DIFF(f) has a negative sign, representing phase advancement. At the angle θ within the shift range Rt at the position of the microphone MIC1, the synchronization coefficient calculator 224 gradually varies the level of the noise suppression process in the sound reception range Rs and the level of the noise suppression process in the suppression range Rn or switches the level of the noise suppression process between the sound reception range Rs and the suppression range Rn.

In the initial set state, the synchronization coefficient calculator 224 calculates a synchronization coefficient C(f) in a range of one set of phase difference sets (Rs=Rsmax, Rt, and Rn) in accordance with the phase difference DIFF(f) of the phase spectral component at each frequency f as described in an equation below. The synchronization coefficient calculator 224 calculates a synchronization coefficient C(f) in a range of one set of phase difference sets (Rs=Rsmax, Rt, and Rn) determined in response to the gradient D(f) in the limited sound reception range state in FIGS. 6A-6E in accordance with the phase difference DIFF(f) of the phase spectral component at each frequency f as described in an equation below.

(a) The synchronization coefficient calculator 224 successively calculates the synchronization coefficient C(f) of each time analysis frame (window) i in fast Fourier transform. Here, i represents a chronological order number of an analysis frame (0, 1, 2, . . . ). If the phase difference DIFF(f) is the value of a phase difference responsive to the angle θ within the suppression range Rn (for example, −π/12<θ≦+π/2, +π/9<θ≦+π/2, or +2π/9<θ≦+π/2), the synchronization coefficient C(f,i)=Cn(f,i) at an initial order number i=0 is calculated as follows:

$$\begin{matrix}C ( f , 0 ) = Cn ( f , 0 ) \\ = IN 1 ( f , 0 ) / IN 2 ( f , 0 ) ,\end{matrix}$$

$$and for order number i > 0 , \\ \begin{matrix}C ( f , i ) = Cn ( f , i ) \\ = α C ( f , i - 1 ) + ( 1 - α ) IN 1 ( f , i ) / IN 2 ( f , i )\end{matrix}$$

IN1(f,i)/IN2(f,i) represents a ratio of the complex spectrum of the input signal to the microphone MIC1 to the complex spectrum of the input signal to the microphone MIC2, i.e., an amplitude ratio and a phase difference of the input signals. In other words, IN1(f,i)/IN2(f,i) represents a reciprocal of a ratio of the complex spectrum of the input signal to the microphone MIC2 to the complex spectrum of the input signal to the microphone MIC1. Here α represents an addition ratio or a combination ratio of a phase delay of a preceding analysis frame for synchronization and falls within a range of 0≦α<1, and (1−α) represents a combination ratio of a phase delay of a current analysis frame to be added for synchronization. The current synchronization coefficient C(f,i) is determined by adding the synchronization coefficient of the preceding analysis frame and the ratio of the complex spectrum of the input signal to the microphone MIC1 to the complex spectrum of the input signal to the microphone MIC2 at a ratio of α:(1−α).

(b) If the phase difference DIFF(f) is the value of a phase difference responsive to the angle θ within the sound reception range Rs (for example, −π/2≦θ±0, −π/2≦θ≦−π/4 or −π/9≦θ≦+π/9), the synchronization coefficient C(f)=Cs(f) is calculated as follows:

C(f)=Cs(f)=exp(−j2πf/fs) or

C(f)=Cs(f)=0 (if synchronization subtraction is not performed)

If the phase difference DIFF(f) is the value of a phase difference responsive to the angle θwithin the shift range Rt (for example, 0<θ≦+π/6, −π/4<θ≦−π/12, or −π/18≦θ≦+π/9 and −π/2≦θ≦−π/6), the synchronization coefficient C(f)=Ct(f) is calculated as a weighted mean of Cs(f) and Cn(f) as follows:

$$\begin{matrix}C ( f ) = Ct ( f ) \\ = Cs ( f ) \times ( θ - θ b ) / ( θ a - θ b ) + Cn ( f ) \times ( θ a - θ ) / ( θ a - θ b )\end{matrix}$$

where θa represents an angle of the border between the shift range Rt and the suppression range Rn, and θb represents an angle of the border between the shift range Rt and the sound reception range Rs.

The phase difference calculator 222 generates the synchronization coefficient C(f) in response to the complex spectra IN1(f) and IN2(f), and then supplies the complex spectra IN1(f) and IN2(f) and the synchronization coefficient C(f) to the filter 300.

As illustrated in FIG. 3B, the synchronizer 332 in the filter 300 synchronizes the complex spectrum IN2(f) with the complex spectrum IN1(f), thereby a synchronized spectrum INs2(f).

INs2(f)=C(f)×IN2(f)

The subtractor 334 subtracts the complex spectrum INs2(f) multiplied by a coefficient γ(f) from the complex spectrum IN1(f) in accordance with the following equation, thereby generating a digital complex spectrum with the noise thereof suppressed, or a complex spectrum Ind(f):

INd(f)=IN1(f)−γ(f)×INs2(f)

where the coefficient γ(f) is a value preset within a range of 0≦γ(f)≦1. The coefficient γ(f) is a function of the frequency f, and is a coefficient adjusting the degree of subtraction of the spectrum INs2(f) depending on the synchronization coefficient. For example, the distortion of a sound signal of a sound coming in the sound reception range Rs is controlled while a noise coming in the suppression range Rn is suppressed. The coefficient γ(f) may be set to be larger with the incoming direction of a sound represented by the phase difference DIFF(f) in the suppression range Rn than in the sound reception range Rs.

The amplifier 336 subsequent to the subtractor 334 gain-controls the digital sound signal INd(t) such that the power level of the digital sound signal INd(t) is substantially constant in the voice segment.

The digital signal processor 200 includes the inverse fast Fourier transformer (IFFT) 382. The inverse fast Fourier transformer 382 receives the complex spectrum INd(f) from the synchronization coefficient calculator 224 and inverse-Fourier-transforms the complex spectrum INd(f) for overlap addition, and thus generates a digital sound signal INd(t) in the time domain at the position of the microphone MIC1.

The output of the inverse fast Fourier transformer 382 is supplied to an input of the application 400 at a subsequent stage thereof.

The output as the digital sound signal INd(t) is used in voice recognition and communications of a cellular phone. The digital sound signal INd(t) is supplied to the application 400. In the application 400, the digital-to-analog converter 404 digital-to-analog converts the digital sound signal INd(t) into an analog signal. The low-pass filter 406 then low-pass filters the analog signal. Alternatively, the digital sound signal INd(t) is stored on the memory 414, and then used by the voice recognizer 416 for voice recognition.

Elements 212, 214, 218, 220-224, 300-334, and 382 illustrated in FIGS. 3M and 3M may represent an integrated circuit or may represent a flowchart of a software program executed by the digital signal processor 200.

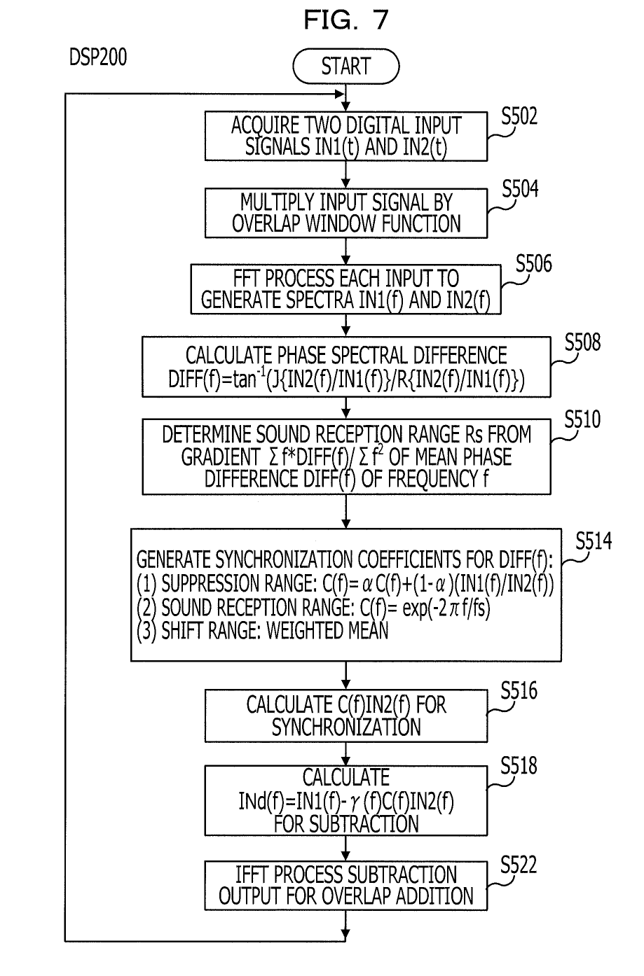

FIG. 7 is a flowchart of a complex spectrum generation process executed by the digital signal processor 200 of FIGS. 3A and 3B in accordance with a program stored on the memory 202. This flowchart represents the function executed by the elements 212, 214, 218, 220, 300, and 382 illustrated in FIGS. 3A and 3B.

Referring to FIGS. 3A, 3B, and 7, the fast Fourier transformers 212 and 214 in the digital signal processor 200 acquires respectively the two digital input signal IN1(t) and IN2(t) in the time domain supplied by the analog-to-digital converters 162 and 164 in operation 502.

In operation 504, the fast Fourier transformers 212 and 214 in the digital signal processor 200 multiply respectively the two digital input signals IN1(t) and INd(t) by an overlap window function.

In operation 506, the fast Fourier transformers 212 and 214 Fourier-transform the digital input signals IN1(t) and INd(t), thereby generating the complex spectra IN1(f) and IN2(f) in the frequency domain.

In operation 508, the phase difference calculator 222 of the synchronization coefficient generator 220 in the digital signal processor 200 calculates the phase difference between the spectra IN1(f) and IN2(f): tan⁻¹(J{In2(f)/In1(f)}/R{IN2(f)/IN1(f)}).

In operation 510, the range determiner 218 in the digital signal processor 200 generates the value of the gradient D(f)=Σf×DIFF(f)/Σf² for all the frequencies f or the frequency f within a particular bandwidth in response to the phase difference DIFF(f). The synchronization coefficient calculator 224 in the digital signal processor 200 sets the limited sound reception range Rs=Rsp, the suppression range Rn, and the shift range Rt on a per frequency f basis in accordance with the data representing the gradient D(f) or the phase difference data (a, a′, b, and b′) of the sound reception range Rs=Rsp responsive to the gradient D(f) (FIGS. 6A-6E).

In operation 514, in response to the phase difference DIFF(f), the synchronization coefficient calculator 224 in the digital signal processor 200 calculates the ratio C(f) of the complex spectrum of the input signal to the microphone MIC1 to the complex spectrum of the input signal to the microphone MIC2 described above in accordance with the following equations.

(a) The synchronization coefficient calculator 224 calculates the synchronization coefficient C(f,i)=Cn(f,i)=αC(f,i−1)+(1−α)IN1(f,i)/IN2(f,i) if the phase difference DIFF(f) has a value corresponding to the angle θ within the suppression range Rn. (b) The synchronization coefficient calculator 224 calculates the synchronization coefficient C(f)=Cs(f)=exp (−j2πf/fs) or C(f)=Cs(f)=0 if the phase difference DIFF(f) has a value corresponding to the angle θ within the sound reception range Rs. (c) The synchronization coefficient calculator 224 calculates the synchronization coefficient C(f)=Ct(f) as the weighted mean value of Cs(f) and Cn(f).

In operation 516, the synchronizer 332 in the digital signal processor 200 calculates the equation INs2(f)=C(f)IN2(f), thereby synchronizing the complex spectrum IN2(f) with the complex spectrum IN1(f). The synchronizer 332 thus generates the synchronized spectrum INs2(f).

In operation 518, the subtractor 334 in the digital signal processor 200 subtracts the product of the complex spectrum INs2(f) and the coefficient γ(f) from the complex spectrum IN1(f) (INd(f)=IN1(f)−γ(f)×IN2(f)). The complex spectrum INd(f) with the noise thereof suppressed thus results.

In operation 522, the inverse fast Fourier transformer 382 in the digital signal processor 200 receives the complex spectrum INd(f) from the synchronization coefficient calculator 224, and inverse-Fourier transforms the complex spectrum INd(f) for overlap addition. The inverse fast Fourier transformer 382 thus generates the sound single INd(t) in the time domain at the position of the microphone MIC1.

Processing returns to operation 502. During a specific period of time, operations 502-522 are repeated to process inputs entered during a specific duration of time.

If a desired target sound source SS or SS′ appears at a particular direction θss, the microphone array device 100 sets the sound reception range Rsp as a limited sound reception range Rs, and thus sufficiently suppresses the noise. The processing of the input signals from the two microphones is applicable to a combination of any two microphones from among a plurality of microphones (FIG. 1).

The microphone array device 100 thus suppresses noise by setting the limited sound reception range Rsp in response to the angular direction of the target sound source as described above. The microphone array device 100 may thus suppress more noise than the method in which the maximum sound reception range Rsmax is reduced to suppress noise regardless of the angular direction of the target sound sources SS and SS′. For example, a suppression gain of about 2 to 3 dB may be achieved by reducing the solid angle of the maximum sound reception range Rsmax to the sound reception range Rsp that is centered at the direction θss of any target sound source and is limited to half the solid angle of the maximum sound reception range Rsmax.

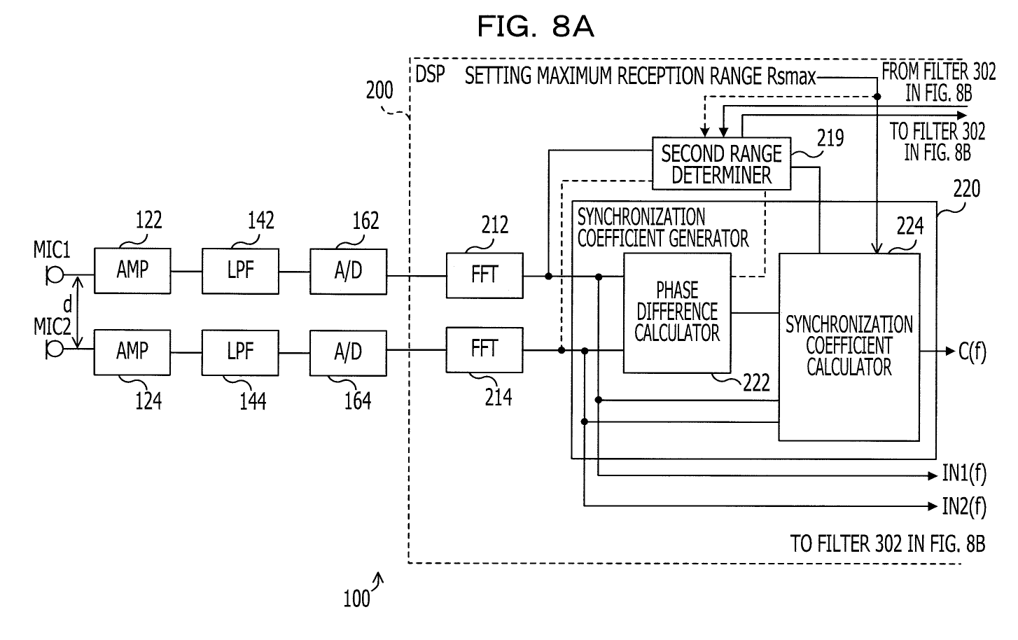

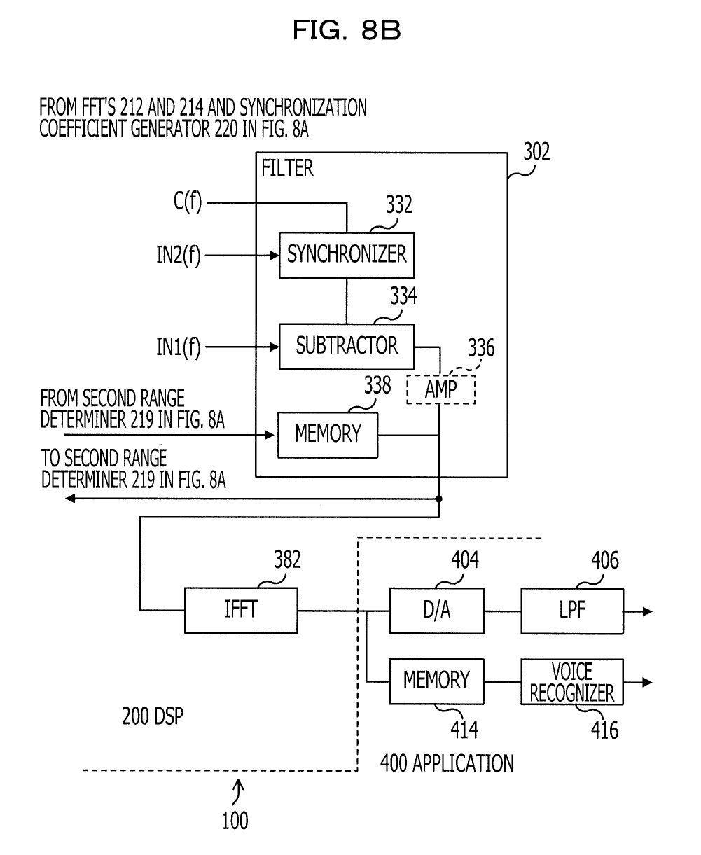

FIGS. 8A and 8B illustrate another general functional structure of the microphone array device 100 that reduces noise by suppressing the noise on the array of the microphones MIC1 and MIC2 of FIG. 1.

The digital signal processor 200 includes fast Fourier transformers 212 and 214, second range determiner 219, synchronization coefficient generator 220, and filter 302. The second range determiner 219 may also function as a suppression range determiner or a target sound source direction determiner. Referring to FIGS. 8A and 8B, the range determiner 218 and the filter 300 in FIGS. 3A and 3B are replaced with the second range determiner 219 and the filter 302, respectively. Let D(f) and Rs represent signals output from the second range determiner 219 to the synchronization coefficient calculator 224.

The synchronization coefficient generator 220 includes the same elements as those illustrated in FIGS. 3A and 3B. In an alternative embodiment, the second range determiner 219 may be included in the synchronization coefficient generator 220. The filter 302 includes the synchronizer 332 and the subtractor 334. Optionally, the filter 302 may include the memory 338 and the amplifier 336. The memory 338 may be connected to the subtractor 334, the inverse fast Fourier transformer 382, and the second range determiner 219. The amplifier 336 may be connected to the subtractor 334 and the inverse fast Fourier transformer 382. Optionally, the amplifier 336 may be connected to the memory 338. In response to a request from the second range determiner 219, the memory 338 may temporarily store the data of the complex spectrum INd(f) from the subtractor 334 and may supply the complex spectrum INd(f) to the second range determiner 219 and the inverse fast Fourier transformer 382.

The second range determiner 219 has an input connected to an output of at least one of the fast Fourier transformers 212 and 214. The second range determiner 219 may have inputs connected to the outputs of the fast Fourier transformers 212 and 214 and the phase difference calculator 222.

The second range determiner 219 determines a plurality of interim ranges of D(f), such as D(f)=−2π/fs, D(f)=0, −2π/fs<D(f)<0, regardless of the phase difference DIFF(f) from the phase difference calculator 222. For D(f) of a range of −2π/fs<D(f)<0, D(f) may be D(f)=−π/4, −π/2fs, −3π/4fs and −π/fs. The second range determiner 219 supplies to the synchronization coefficient calculator 224 the data presenting the interim gradient D(f) or the phase difference data (a, a′, b, and b′) representing the sound reception range Rs responsive to the gradient D(f). In response to the interim gradient D(f) or the sound reception range Rs responsive to the gradient D(f), one of the second-range determiner 219 and the synchronization coefficient calculator 224 sets a plurality of q sets of interim limited sound reception ranges Rs, shift ranges Rt, and suppression ranges Rn for all the frequencies f or the frequency f within the particular bandwidth.

In response to the phase difference DIFF(f) of the phase spectral component of each of all the frequencies f or the frequency f within the particular bandwidth, the synchronization coefficient calculator 224 calculates the synchronization coefficient C(f) with respect to the limited interim sound reception range Rsp, the suppression range Rn, and the shift range Rt of each set.

In response to the synchronization coefficient C(f), the filter 302 generates the data of the noise-suppressed complex spectra INd(f)q for all the frequencies f or the frequency f within the particular bandwidth with respect to the interim sets q (Rsp, Rt, Rn) including the interim limited sound reception range Rsp. The filter 302 then supplies the data of the complex spectra INd(f)q to the second range determiner 219. The data of the complex spectra INd(f)q is temporarily stored on the memory 338.

The second range determiner 219 determines the overall power of the complex spectra INd(f)q for all the frequencies f or the frequency f within the particular bandwidth with respect to the interim sets q (Rsp, Rt, Rn) including the interim limited sound reception range Rsp. The second range determiner 219 selects identification information of the complex spectra INd(f)q indicating maximum overall power, and supplies the identification information to the memory 338 in the filter 302. The memory 338 supplies the corresponding complex spectra INd(f)q to the inverse fast Fourier transformer 382. In an alternative embodiment, the sum of S/N ratios may be used instead of the overall power.

Optionally, on each frequency f, the second range determiner 219 may determine the overall power of a portion of the complex spectra INd(f)q having a power spectral component higher than a power spectral component N of the estimated noise N. In this process, the second range determiner 219 may determine the noise power on each frequency f in the power spectrum having a silence pattern in the complex spectra INd(f)q, and then estimates the noise power as the steady noise power N.

In addition to or in alternative to the determination based on the estimated noise power N, the second range determiner 219 may determine whether power P1 of the complex spectrum IN1(f) and power P2 of the complex spectrum IN2(f) satisfy a general relationship of P1≧P2+ΔP (ΔP is an error tolerance determined by the design engineer). The phase difference DIFF(f) failing to satisfy P1≧P2+ΔP may be excluded from the overall power.

The determination based on the estimated noise power N and/or the comparison of power of the complex spectra IN1(f) and IN2(f) result in the overall power of the sound signal from mainly the target sound source SS or the overall S/N ratio. The power from the noises N1 and N2 is thus excluded as much as possible.

The second range determiner 219 may select or determine the gradient D(f)q or the sound reception range Rspq (FIGS. 6A-6E) having a limited phase difference corresponding to one complex spectrum INd(f)q indicating the maximum overall power.

In response to the gradient D(f)q or the phase difference data (a, a′, b, and b′) of the limited the sound reception range Rspq, the synchronization coefficient generator 220 determines or selects the synchronization coefficient C(f) on a per frequency f basis of all the frequencies. In response to the synchronization coefficient C(f), the filter 302 generates or determines the complex spectrum INd(f) having the noise thereof suppressed on a per frequency f basis of all the frequencies with respect to the sets q (Rs, Rt, Rn) including the limited sound reception range Rspq. The filter 302 then supplies the complex spectrum INd(f) to the inverse fast Fourier transformer 382.

In an alternative embodiment, the second range determiner 219 may supply to the filter 302 the complex spectra INd(f)q having maximum overall power, and the memory 338 may supply to the inverse fast Fourier transformer 382 the corresponding complex spectra INd(f)q of all the frequencies f.

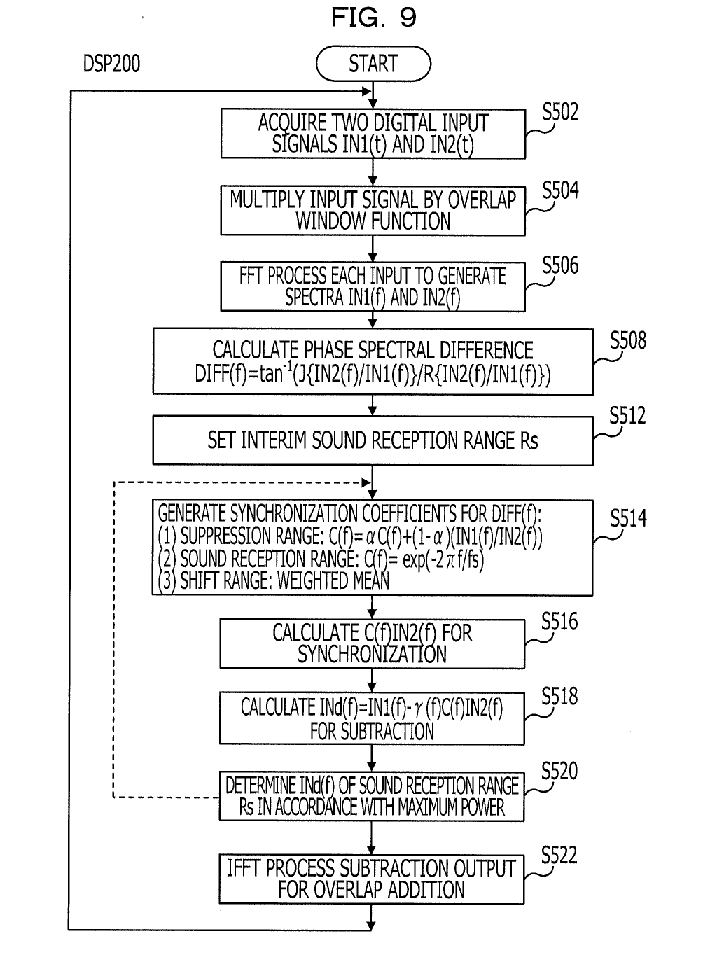

FIG. 9 is a flowchart illustrating a generation process of a complex spectrum the digital signal processor 200 of FIGS. 8A and 8B executes in accordance with a program stored on the memory 202. The process represented by the flowchart corresponds to the function to be performed by elements 212, 214, 219, 220, 302, and 382 of FIGS. 8A and 8B.

Referring to FIG. 9, operations 502, 504, 506 and, 508 (502-508) are identical to those illustrated in FIG. 7. However, the range determiner 218 and the filter 300 in FIGS. 3A and 3B are replaced with the second range determiner 219 and the filter 302 in FIGS. 8A and 8B, respectively.

In operation 512, the second range determiner 219 in the digital signal processor 200 determines a plurality of different interim gradients D(f) regardless of the phase difference DIFF(f). In response to the data representing the interim gradient D(f) or the phase difference data representing the sound reception range Rs responsive to the gradient D(f), the synchronization coefficient calculator 224 sets the interim limited sound reception range Rs=Rsp, the suppression range Rn, and the shift range Rt on all the frequencies f or the frequency f within the particular bandwidth (FIGS. 6A-6E).

Operations 514-518 are identical to those of FIG. 7. Operations 514-518 are executed on all the frequencies f or the frequency f within the particular bandwidth with respect to all the plurality of q sets (Rs=Rsp, Rt, Rn) including the interim limited sound reception range Rs=Rsp.

In operation 518, the subtractor 334 of the filter 302 in the digital signal processor 200 generates the complex spectrum INd(f) having the noise thereof suppressed, and then stores the complex spectrum INd(f) on the memory 338.

In operation 520, the second range determiner 219 in the digital signal processor 200 selects the complex spectrum INd(f)q having maximum overall power, or the corresponding the gradient D(f)q, or the phase difference data indicating the limited sound reception range Rspq. The synchronization coefficient calculator 224 and the filter 302 in the digital signal processor 200 generate new complex spectra INd(f)q for all the frequencies f by repeating operations 514 through 520 as denoted by an arrow-headed broken line. The newly generated complex spectra INd(f)q are supplied to the inverse fast Fourier transformer 382. In an alternative embodiment, the memory 338 of the filter 302 in the digital signal processor 200 may supply to the inverse fast Fourier transformer 382 the complex spectra INd(f)q of all the frequencies f.

Operation 522 is identical to operation 522 in FIG. 7.

The complex spectrum INd(f) is thus determined for a plurality of interim limited sound reception ranges Rsp. This process eliminates the need for the process of determining the coefficient D(f) of the phase difference DIFF(f) representing the direction Ess of the target sound sources SS and SS′ in FIGS. 3A and 3B

In one embodiment, after the selection or determination of the gradient D(f)q as in FIGS. 8A and 8B, the second range determiner 219 may determine the gradient D(f) again in accordance with the sound reception range Rspq of the selected phase difference and the phase difference DIFF(f) corresponding to the complex spectrum INd(f) using the above-described equation D(f)=Σf×DIFF(f)/Σf². In this case, the second range determiner 219 supplies to one of the synchronization coefficient generator 220 and the filter 302 the data of the selected gradient D(f)q or the phase difference data of the corresponding limited sound reception range Rspq.

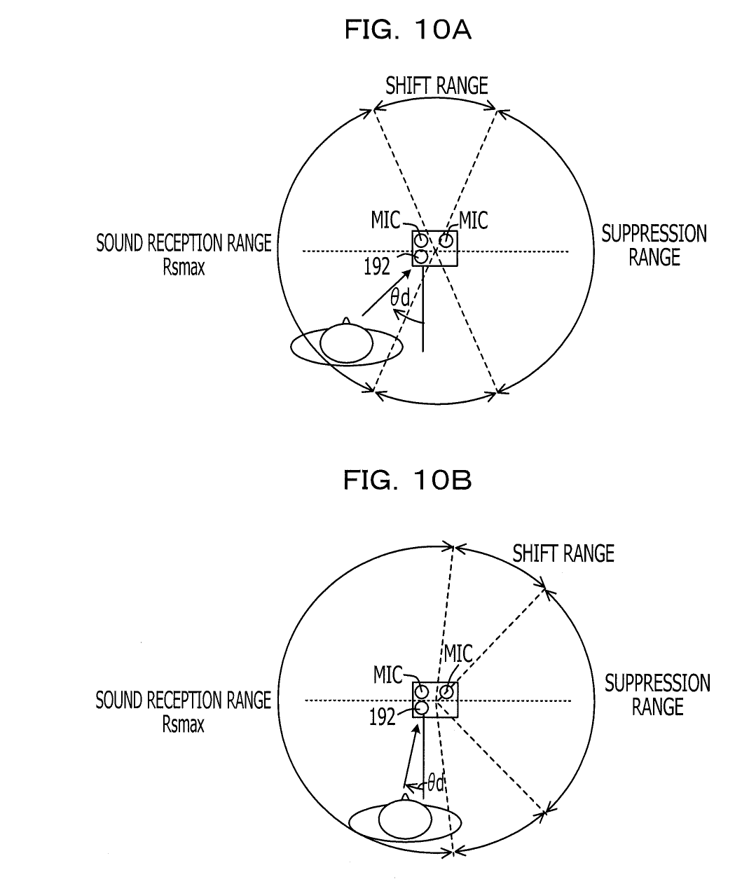

FIGS. 10A and 10B illustrate a set state of a maximum sound reception range Rsmax set in response to and relative to data from the sensor 192 or key input data. The sensor 192 detects a position of or the angular direction θd to the body of a talker. In response to the detected position or the angular direction θd, the direction determiner 194 determines the maximum sound reception range Rsmax covering the body of the talker. The phase difference data representing the maximum sound reception range Rsmax is supplied to the synchronization coefficient calculator 224 in the synchronization coefficient generator 220. In response to the maximum sound reception range Rsmax, the synchronization coefficient calculator 224 sets the maximum sound reception range Rsmax, the suppression range Rn, and the shift range Rt as previously discussed.

As illustrated in FIG. 10A, the face of the talker is on the left to the sensor 192. The sensor 192 detects the angle θd=θ1=−π/4 of the face region A of the talker as the angular position of the maximum sound reception range Rsmax. Based on the detected data θd=θ1, the direction determiner 194 sets the angular range of the maximum sound reception range Rsmax to an angular range of −π/2≦θ≦±0 to include the entire face region A.

As illustrated in FIG. 10B, the face of the talker is arranged below or in front of the sensor 192. The sensor 192 detects the center position ed of the face region A of the talker at the angle θd=θ2=±0 as the angular position in the maximum sound reception range Rsmax. Based on the detected data θd=θ2, the direction determiner 194 sets the angular range of the maximum sound reception range Rsmax to an angular range of −π/2≦θd≦+π/12 to include the entire face region A.

If the sensor 192 is a digital camera, the direction determiner 194 image-recognizes image data captured from the digital camera, and determines the face region A and the center position Od of the face region A. The direction determiner 194 determines the maximum sound reception range Rsmax in response to the face region A and the center position Od of the face region A.

The direction determiner 194 may variably set the maximum sound reception range Rsmax in accordance with the position of the face or the body of the talker detected by the sensor 192. In an alternative embodiment, the direction determiner 194 may variably set the maximum sound reception range Rsmax in response to key inputting. By variably setting the maximum sound reception range Rsmax, the maximum sound reception range Rsmax may be narrowed as much as possible, and unwanted noise of each frequency is suppressed in a suppression range Rn as wide as possible.

The microphones MIC1 and MIC2 of FIG. 1 have been mainly discussed. If the main target sound source SS is placed on the right-hand side in an arrangement opposite the arrangement of FIG. 1, the digital signal processor 200 illustrated in FIGS. 3A and 3B, or FIGS. 8A and 8B may perform the same process as described above with the microphones MIC1 and MIC2 laterally inverted in position. Alternatively, the processes performed on the two sound signals IN1(t) and IN2(t) from the microphones MIC1 and MIC2 may be inverted on the digital signal processor 200 illustrated in FIGS. 3A and 3B, or FIGS. 8A and 8B.

A computer-implemented method of signal processing includes determining a maximum sound range for processing at least two sound signals from separate sources based on detection of a position of a participant and processing the two sound signals relative to the maximum sound range determined.

In one alternative embodiment, a synchronization addition process may be performed for sound signal enhancement rather than the synchronization subtraction related to the noise suppression. In the synchronization addition process, the synchronization addition may be performed if the sound reception direction is within the sound reception range, and the synchronization addition may not be performed or the addition ratio of the additional signal may be reduced even with the synchronization performed if the sound reception direction is within the suppression range.

All examples and expressions about conditions described above are intended to help the readers understand the invention or the concept of the invention to which the inventor has contributed. The examples and the expressions may be interpreted without any limitation. The configuration of the examples in the specification is not related to the quality of the invention. The embodiments of the invention have been discussed in detail, and may be modified, substituted, and changed without departing from the scope and spirit of the invention.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A signal processing apparatus, comprising:
at least two sound input units;
an orthogonal transformer to transform two sound signals, out of sound signals in a time domain input from the at least two sound input units, into respective spectral signals in a frequency domain;
a phase difference calculator to calculate a phase difference between the spectral signals in the frequency domain;
a range determiner to determine a coefficient responsive to a frequency in the phase difference as a function of frequency, and determine a suppression range related to a phase on a per frequency basis of the frequency responsive to the coefficient; and
a filter to phase-shift a component of a first of the spectral signals on a per frequency basis in order to generate a phase-shifted spectral signal when the phase difference at each frequency falls within the suppression range, synthesizing the phase-shifted spectral signal and a second of the spectral signals in order to generate a filtered spectral signal.

2. The signal processing apparatus according to claim 1, wherein the range determiner determines the suppression range based on the coefficient of the phase difference, and
wherein the phase difference is within a reception range related to the phase at each frequency prior to the determination of the suppression range.

3. The signal processing apparatus according to claim 1, wherein the range determiner determines based on the coefficient a narrower than a first reception range such that a noise suppression quantity becomes constant, based on the coefficient of the phase difference, and
wherein the phase difference is within the first reception range related to the phase at each frequency prior to the determination of the suppression range.

4. The signal processing apparatus according to claim 1, wherein the range determiner estimates a noise spectrum of the two spectral signals, and determines the coefficient of the phase difference related to the frequency of the two spectral signals having a power higher than a power of the noise spectrum estimated.

5. The signal processing apparatus according to claim 1, wherein the range determiner determines as a statistical mean value the coefficient of the phase difference by statistically processing a plurality of phase differences for different frequencies.

6. The signal processing apparatus according to claim 1, wherein the range determiner tentatively determines at least first and second suppression ranges respectively corresponding to at least first and second coefficients as the coefficients, determines a first power of a first filtered spectral signal as the filtered spectral signal when the phase difference on a specific frequency falls within the first suppression range, and a second power of a second filtered spectral signal as the filtered spectral signal when the phase difference on the specific frequency falls within the second suppression range, and compares the first power with the second power and selects the first suppression range or the second suppression range respectively corresponding to the first power or the second power, whichever is higher, and
wherein the filter generates the filtered spectral signal with the phase difference falling within the selected suppression range.

7. A microphone array device, comprising:
at least two microphones;
an orthogonal transformer to transform two sound signals, out of the sound signals in a time domain input from the at least two microphones, into respective spectral signals in a frequency domain;
a phase difference calculator to calculate a phase difference between the spectral signals in the frequency domain;
a range determiner to determine a coefficient responsive to a frequency in the phase difference as a function of frequency, and determining a suppression range related to a phase on a per frequency basis of the frequency responsive to the coefficient;
a filter to phase-shift a component of a first of the spectral signals on a per frequency basis in order to generate a phase-shifted spectral signal when the phase difference at each frequency falls within the suppression range, synthesizing the phase-shifted spectral signal and a second of the spectral signals in order to generate a filtered spectral signal; and
an inverse-orthogonal transformer to inverse-transform the filtered spectral signal into a sound signal in the time domain.

8. A non-transitory computer-readable medium for recording a signal processing program allowing a computer to execute an operation, comprising:
transforming two sound signals, out of sound signals in a time domain input from at least two sound input units, into respective spectral signals in a frequency domain;
calculating a phase difference between the spectral signals in the frequency domain;
determining a suppression range related to a phase on a per frequency basis of the frequency responsive to a coefficient of the frequency in the phase difference as a function of frequency;
phase-shifting a component of a first of the spectral signals on a per frequency basis in order to generate a phase-shifted spectral signal when the phase difference at each frequency falls within the suppression range, synthesizing the phase-shifted spectral signal and a second of the spectral signals in order to generate a filtered spectral signal.

9. The computer-readable medium according to claim 8, wherein the determining determines the suppression range based on the coefficient of the phase difference, and
wherein the phase difference is within a reception range related to the phase at each frequency prior to the determination of the suppression range.

10. The computer-readable medium according to claim 8, wherein the determining determines based on the coefficient and a narrower than a first reception range such that a noise suppression quantity becomes constant, based on the coefficient of the phase difference, and
wherein the phase difference is within the first reception range related to the phase at each frequency prior to the determination of the suppression range.

11. The computer-readable medium according to claim 8, wherein the determining estimates a noise spectrum of the spectral signals, and determines the coefficient of the phase difference related to the frequency of the spectral signals having a power higher than a power of the noise spectrum estimated.

12. The computer-readable medium according to claim 8, wherein the determining determines as a statistical mean value the coefficient of the phase difference by processing a plurality of phase differences for different frequencies.

13. The computer-readable medium according to claim 8, wherein the determining tentatively determines at least first and second suppression ranges respectively corresponding to at least first and second coefficients as the coefficients, determines a first power of a first filtered spectral signal as the filtered spectral signal when the phase difference on a specific frequency falls within the first suppression range, and a second power of a second filtered spectral signal as the filtered spectral signal when the phase difference on the specific frequency falls within the second suppression range, and compares the first power with the second power and selects the first suppression range or the second suppression range respectively corresponding to the first power or the second power, whichever is higher, and
wherein the filter generates the filtered spectral signal with the phase difference falling within the selected suppression range.
